(19) United States
(12) Patent Application Publication
(10) Pub. No.: US 2006/0047438 A1
(43) Pub. Date: Mar. 2, 2006

(54) Identification of different regions of biopolymer sequences using a denoiser

(76) Inventors: Erik Ordentlich, San Jose, CA (US); Gadiel Seroussi, Cupertino, CA (US); Sergio Verdu, Princeton, NJ (US); Marcelo Weinberger, San Jose, CA (US); Ischak Weissman, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/934,221

(22) Filed: Sep. 2, 2004

(51) Int. Cl. G06F 19/00

(52) U.S. Cl. 702/19

(57) ABSTRACT

Various embodiments of the present invention are directed to analysis of biopolymer sequences by introducing artificial noise into the sequences and then applying a denoiser to remove the artificial noise, monitoring the denoisability of each portion of the sequence by comparing the product of the denoiser and the original sequence. Portions of biopolymer sequences involved in certain cellular functions, such as genes within DNA sequences, often encode information in codes that are highly resilient to discrete, local corruption, such as DNA sequence mutations. Portions of DNA involved in other types of cellular functions may be less resilient to random errors, or, in other cases, may be so uniformly repetitive in sequence that random errors can be extremely easily identified and corrected. The denoisability of portions of biopolymer sequences into which random errors are introduced may thus rather directly reflect the error tolerance and error recognizability within the portions of biopolymer sequences. Rapid changes in denoisability in a continuous computation of denoisability along a biopolymer sequence may, in turn, indicate boundaries between portions of the biopolymer sequence having different biological functions. Thus, a denoiser may be a computationally efficient tool for analyzing biopolymer sequences in order to differentiate different portions of the biopolymer sequences having different biological functions.

### TECHNICAL FIELD

The present invention is related to semantic analysis of biopolymer sequences in the general area of bioinformatics and, in particular, to a computationally efficient method for identifying different regions of a biopolymer, such as coding and non-coding regions of a DNA polymer.

### BACKGROUND OF THE INVENTION

During the past 50 years, biological sciences have progressed from a vague understanding that DNA biopolymers somehow contain genetic information to a spectacularly detailed understanding of the encoding of genetic information in DNA biopolymers and detailed, full DNA sequences for a number of different organisms, including humans. These advances in biological sciences have provided a wealth of biopolymer sequence information, commonly stored in large databases, including databases containing the amino acid sequences of proteins, deoxyribonucleotide sequences of DNA polymers, nucleotide sequences of RNA polymers, and highly branched sequences of many biologically important polysaccharides. However, analysis of this wealth of biological information has only just begun.

Organisms are vastly complex, highly dynamical entities, both affecting and responding to their immediate environments. Portions of the information stored in DNA biopolymers, for example, are extracted at different time points and under different environmental and developmental circumstances to serve as templates for other biopolymers, and to facilitate organization, in time, of myriad biochemical pathways, events, and interactions. Eventual understanding of biological systems at the molecular level will require detailed mathematical and computational models of the time-dependent behavior and interactions of biomolecules, including biopolymers. Processing the available wealth of information is currently underway in many research laboratories and institutions, and involves application of bioinformatics techniques to the biopolymer sequence information stored in massive databases. One task of the analysis is to initially identify regions of biopolymers, or portions of biopolymer sequences, likely serving in various different types of biological capacities and functions. For example, regions of DNA polymers may be involved in gene regulation, encoding of amino-acid sequences of proteins, peptide hormones, and other polypeptides, encoding of RNA sequences, various structural functions, and probably many functions not yet imagined. Great efforts are currently underway to develop computational techniques for processing the massive quantities of sequence information in order to categorize portions of the sequences for further, directed analysis. Researchers in bioinformatics, biostatistics, molecular biology, structural genomics, proteomics, and a large number of other, related biological science fields, have recognized and continue to recognize the need for new computational methods for analyzing biopolymer sequences in order to identify portions of the biopolymer sequences likely to be involved in, or represent, different types of functions.

### SUMMARY OF THE INVENTION

Various embodiments of the present invention are directed to analysis of biopolymer sequences by introducing artificial noise into the sequences and then applying a denoiser to remove the artificial noise, monitoring the denoisability of each portion of the sequence by comparing the product of the denoiser and the original sequence. Portions of biopolymer sequences involved in certain cellular functions, such as genes within DNA sequences, often encode information in codes that are highly resilient to discrete, local corruption, such as DNA sequence mutations. Portions of DNA involved in other types of cellular functions may be less resilient to random errors, or, in other cases, may be so uniformly repetitive in sequence that random errors can be extremely easily identified and corrected. The denoisability of portions of biopolymer sequences into which random errors are introduced may thus rather directly reflect the error tolerance and error recognizability within the portions of biopolymer sequences. Rapid changes in denoisability in a continuous computation of denoisability along a biopolymer sequence may, in turn, indicate boundaries between portions of the biopolymer sequence having different biological functions. Thus, a denoiser may be a computationally efficient tool for analyzing biopolymer sequences in order to differentiate different portions of the biopolymer sequences having different biological functions.

### BRIEF DESCRIPTION OF THE DRAWINGS

FIG. 1 illustrates introduction of noise into a clear signal to produce a noisy signal and subsequent denoising of the noisy signal to produce a recovered signal.

FIGS. 2A-D illustrate a motivation for a discrete denoiser related to characteristics of the noise-introducing channel.

FIGS. 3A-D illustrate a context-based, sliding window approach by which a discrete denoiser characterizes the occurrences of symbols in a noisy signal.

FIG. 4 illustrates a convenient mathematical notation and data structure representing a portion of the metasymbol table constructed by a discrete denoiser, as described with reference to FIGS. 3A-D.

FIGS. 5A-D illustrate the concept of symbol-corruption-related distortion in a noisy or recovered signal.

FIG. 6 displays one form of the symbol-transformation distortion matrixA.

FIG. 7 illustrates computation of the relative distortion expected from replacing a symbol “aₐ ” in a received, noisy signal by the symbol “aₓ.”

FIG. 8 illustrates use of the column vector λₐ_{ₓ}πₐ_{ₐ} to compute a distortion expected for replacing the metasymbol baₐc in a noisy signal “a_{noisy}” by the replacement metasymbol baₓc.

FIG. 9 shows estimation of the counts of the occurrences of symbols “a₁”-“aₙ” for the clear signal.

FIG. 10 illustrates the process by which a discrete denoiser denoises a noisy, received signal.

FIG. 11 shows the chemical structures of the 20 commonly occurring amino acids.

FIG. 12 illustrates a four-amino-acid peptide, including an alanine subunit, a tyrosine subunit, an aspartic acid subunit, and a glycine subunit.

FIG. 13 shows a ball-and-stick representation of the structure of a typical protein.

FIG. 14 shows a four-deoxynucleotide DNA polymer containing one of each of the commonly occurring deoxynucleotide monomers.

FIG. 15 illustrates hydrogen bonding that occurs between complementary bases of complementary nucleotides within a double-stranded DNA polymer.

FIG. 16 shows the familiar double-helix confirmation of a double-stranded DNA polymer.

FIG. 17 illustrates the process by which a gene sequence is decoded to produce the amino-acid sequence of a protein.

FIG. 18 shows a table for the encoding of amino acids by nucleotide triplets within an mRNA sequence.

FIG. 19 illustrates a series of single-nucleotide transformations of triplet codons, starting with the nucleotide code “UUU” for phenylalanine.

FIG. 20 shows a series of single-nucleotide substitutions starting with the triplet code for histidine “CAU.”

FIG. 21 illustrates the different levels of implications of amino-acid sequences within proteins.

FIG. 22 illustrates a hypothetical portion of a chromosomal double-stranded DNA polymer.

FIG. 23 graphically illustrates an assumption that provides significant motivation for the present invention.

FIG. 24 illustrates one, general embodiment of the present invention.

FIG. 25 illustrates an imaginary laboratory device that illustrates aspects of the present invention.

FIG. 26 shows an alternate, imaginary embodiment of the present invention.

FIG. 27 is a control-flow diagram of one embodiment of the present invention implemented as a software program “analyzeSequence.”

### DETAILED DESCRIPTION OF THE INVENTION

Embodiments of the present invention are related to analysis of biopolymer sequences in order to identify portions of the biopolymer sequences involved in different biological functions. In order to provide a reasonable basis for discussion of the embodiments of the present invention, an implementation of a discrete denoiser, referred to as the “DUDE,” is described in a first subsection, below. In a second subsection, an overview of biopolymer sequences is provided. Finally, in a third subsection, application of the discrete denoiser to the problem of biopolymer-sequence analysis is described.

### Dude

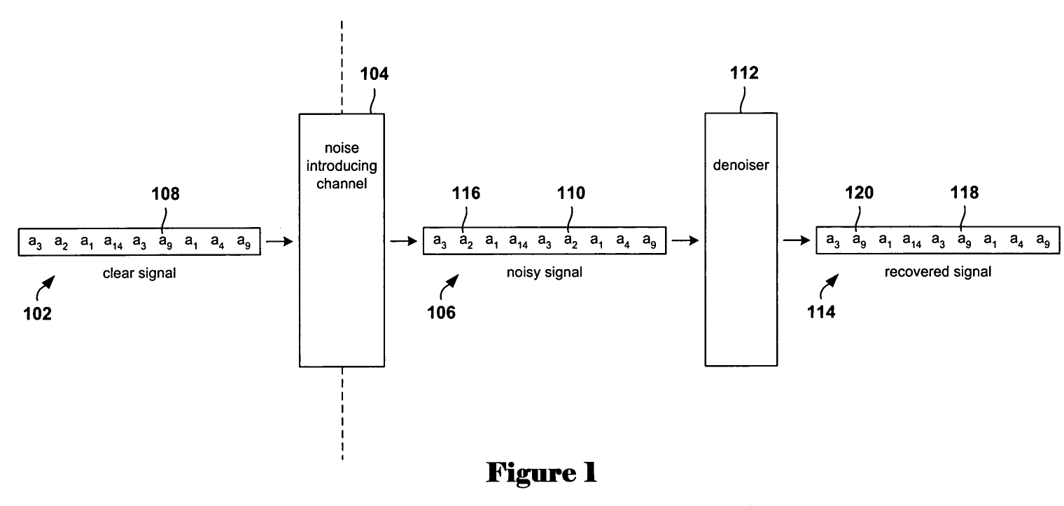

FIG. 1 illustrates introduction of noise into a clean signal to produce a noisy signal and subsequent denoising of the noisy signal to produce a recovered signal. In FIG. 1, signals are represented as sequences of symbols that are each members of an alphabet A having n distinct symbols, where A is:
A=(a₁,a₂,a₃, . . . aₙ)
Note that the subscripts refer to the positions of the respective symbols within an ordered listing of the different symbols of the alphabet, and not to the positions of symbols in a signal. In FIG. 1, an initial, clean signal 102 comprises an ordered sequence of nine symbols from the alphabet A. In normal circumstances, an input signal would generally have thousands, millions, or more symbols. The short input signal 102 is used for illustrative convenience.

The clean signal 102 is transmitted or passed through a noise-introducing channel 104, producing a noisy signal 106. In the example shown in FIG. 1, the output signal 106 comprises symbols from the same alphabet as the input signal 102, although, in general, the input symbols may be chosen from a different, equally sized or smaller alphabet than that from which the output symbols are selected. In the example shown in FIG. 1, the sixth symbol in the clean signal 108, “a₉,” is altered by the noise-introducing channel to produce the symbol “a₂” 110 in the noisy signal 106. There are many different types of noise-introducing channels, each type characterized by the types and magnitudes of noise that the noise-introducing channel introduces into a clean signal. Examples of noise-introducing channels include electronic communications media, data storage devices to which information is transferred and from which information is extracted, and transmission and reception of radio and television signals. In this discussion, a signal is treated as a linear, ordered sequence of symbols, such as a stream of alphanumeric characters that comprise a text file, but the actual data into which noise is introduced by noise-introducing channels in real world situations may include two-dimensional images, audio signals, video signals, and other types of displayed and broadcast information.

In order to display, broadcast, or store a received, noisy signal with reasonable fidelity with respect to the initially transmitted clean signal, a denoising process may be undertaken to remove noise introduced into the clean signal by a noise-introducing channel. In FIG. 1, the noisy signal 106 is passed through, or processed by, a denoiser 112 to produce a recovered signal 114 which, when the denoising process is effective, is substantially closer to, or more perceptually similar to, the originally transmitted clean signal than to the received noisy signal.

Many types of denoisers have been proposed, studied, and implemented. Some involve application of continuous mathematics, some involve detailed knowledge of the statistical properties of the originally transmitted clean signal, and some rely on detailed information concerning time and sequence-dependent behavior of the noise-introducing channel. The following discussion describes a discrete denoiser, referred to as “DUDE,” related to the present invention. The DUDE is discrete in the sense that the DUDE processes signals comprising discrete symbols using a discrete algorithm, rather than continuous mathematics. The DUDE is universal in that it asymptotically approaches the performance of an optimum denoiser employing knowledge of the clean-signal symbol-occurrence distributions without access to these distributions.

The DUDE implementation is motivated by a particular noise-introducing-channel model and a number of assumptions. These are discussed below. However, DUDE may effectively function when the model and assumptions do not, in fact, correspond to the particular characteristics and nature of a noise-introducing channel. Thus, the model and assumptions motivate the DUDE approach, but the DUDE has a much greater range of effectiveness and applicability than merely to denoising signals corrupted by a noise-introducing channel corresponding to the motivating model and assumptions.

As shown in FIG. 1, the DUDE 112 employs a particular strategy for denoising a noisy signal. The DUDE considers each symbol within a context generally comprising one or more symbols preceding and following the symbol according to a left to right ordering. For example, in FIG. 1, the two occurrences of the symbol “a₂” in the noisy signal 106 occur within the same single preceding-and-following-symbol context. The full context for the two occurrences of the symbol “a₂” in the noisy signal 106 of the example in FIG. 1 is [“a₃,” “a₁”]. The DUDE either leaves all symbols of a particular type “aᵢ” within a particular context unchanged, or changes all occurrences of a particular type of symbol “aᵢ” within a particular context to a different symbol “aⱼ.” For example, in FIG. 1, the denoiser has replaced all occurrences of the symbol “a₂” 110 and 112 in the noisy signal within the full context [“a₃,” “a₁”] with the symbol “a₉” 114 and 116 in the recovered symbol. Thus, the DUDE does not necessarily produce a recovered signal identical to the originally transmitted clean signal, but instead produces a denoised, recovered signal estimated to have less distortion with respect to the clean signal than the noisy signal. In the above example, replacement of the second symbol “a₂” 110 with the symbol “a₉” 114 restores the originally transmitted symbol at that position, but replacement of the first occurrence of symbol “a₂” 112 in the noisy signal with the symbol “a₉” 116 introduces a new distortion. The DUDE only replaces one symbol with another to produce the recovered signal when the DUDE estimates that the overall distortion of the recovered signal with respect to the clean signal will be less than the distortion of the noisy signal with respect to the clean signal.

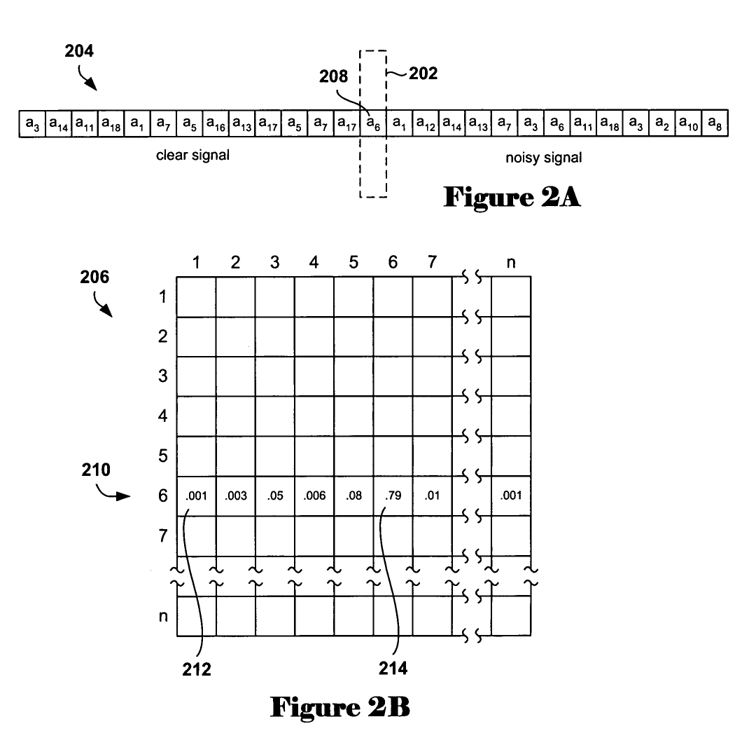

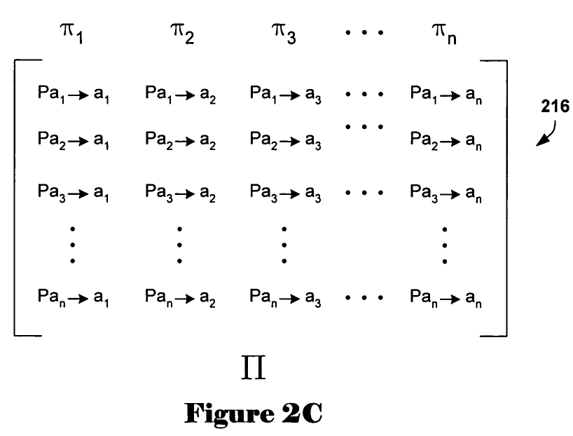

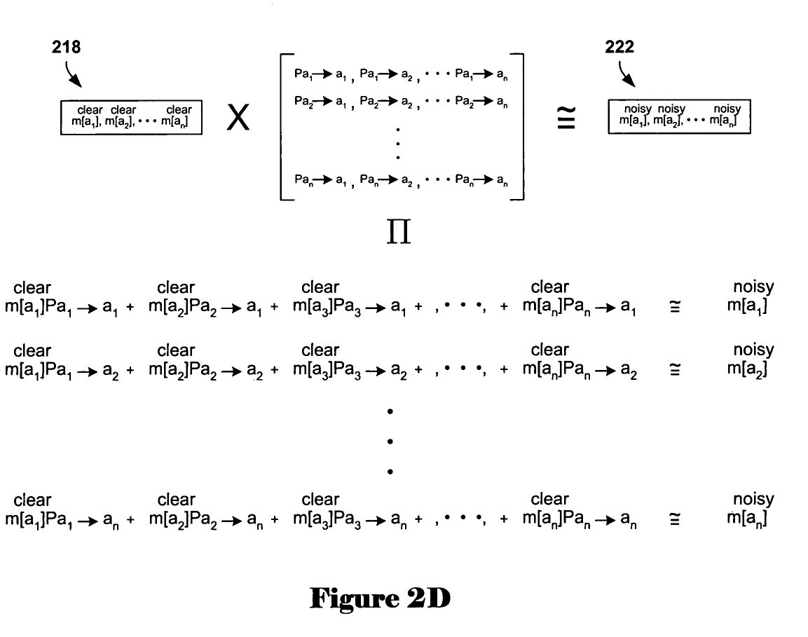

FIGS. 2A-D illustrate a motivation for DUDE related to characteristics of the noise-introducing channel. DUDE assumes a memory-less channel. In other words, as shown in FIG. 2A, the noise-introducing channel 202 may be considered to act as a one-symbol window, or aperture, through which a clean signal 204 passes. The noise-introducing channel 202 corrupts a given clean-signal symbol, replacing the given symbol with another symbol in the noisy signal, with an estimateable probability that depends neither on the history of symbols preceding the symbol through the noise-introducing channel nor on the symbols that are subsequently transmitted through the noise-introducing channel.

FIG. 2B shows a portion of a table 206 that stores the probabilities that any particular symbol from the alphabet A, “aᵢ,” may be corrupted to a symbol “aⱼ” during transmission through the noise-introducing channel. For example, in FIG. 2A, the symbol “a₆” 208 is currently passing through the noise-introducing channel. Row 210 in table 206 contains the probabilities that symbol “a₆” will be corrupted to each of the different, possible symbols in the alphabet A. For example, the probability that the symbol “a₆” will be changed to the symbol “a₁” 212 appears in the first cell of row 210 in table 206, indexed by the integers “6” and “1” corresponding to the positions of symbols “a₆” and “a₁” in the alphabet A. The probability that symbol “a₆” will be faithfully transferred, without corruption, through the noise-introducing channel 214 appears in the table cell with indices (6, 6), the probability of symbol “a₆” being transmitted as the symbol “a₆.” Note that the sum of the probabilities in each row of the table 206 is 1.0, since a given symbol will be transmitted by the noise-introducing channel either faithfully or it will be corrupted to some other symbol in alphabet A. As shown in FIG. 2C, table 206 in FIG. 2B can be alternatively expressed as a two-dimensional matrix Π 216, with the matrix element identified by indices (i, j) indicating the probability that symbol “aᵢ” will be transmitted by the noise-introducing channel as symbol “aⱼ.” Note also that a column j in matrix Π may be referred to as “πⱼ” or πₐ_{ⱼ}.

As shown in FIG. 2D, a row vector 218 containing the counts of the number of each type of symbol in the clean signal, where, for example, the number of occurrences of the symbol “a₅” in the clean signal appears in the row vector as m^{clean}[a₅], can be multiplied by the symbol-transition-probability matrix Π 220 to produce a row vector 222 containing the expected counts for each of the symbols in the noisy signal. The actual occurrence counts of symbols “aᵢ” in the noisy signal appear in the row vector m^{noisy}. The matrix multiplication is shown in expanded form 224 below the matrix multiplication in FIG. 2D. Thus, in vector notation:
m^{clean}Π≅m^{noisy}
where
m^{clean} is a row vector containing the occurrence counts of each symbol aᵢ in alphabet A in the clean signal; and
m^{noisy} is a row vector containing the occurrence counts of each symbol aᵢ in alphabet A in the noisy signal.
   The approximation symbol ≅ is employed in the above equation, because the probabilities in the matrix Π give only the expected frequency of a particular symbol substitution, while the actual symbol substitution effected by the noise-introducing channel is random. In other words, the noise-introducing channel behaves randomly, rather than deterministically, and thus may produce different results each time a particular clean signal is transmitted through the noise-introducing channel. The error in the approximation, obtained as the sum of the absolute values of the components of the difference between the left and right sides of the approximation, above, is generally small relative to the sequence length, on the order of the square root of the sequence length. Multiplying, from the right, both sides of the above equation by the inverse of matrix Π, assuming that Π is invertible, allows for calculation of an estimated row-vector count of the symbols in the clean signal, \hat{m}^{clean}, from the counts of the symbols in the noisy signal, as follows:
   \hat{m}^{clean}=m^{noisy}Π⁻¹
   In the case where the noisy symbol alphabet is larger than the clean symbol alphabet, it is assumed that Π is full-row-rank and the inverse in the above expression can be replaced by a generalized inverse, such as the Moore-Penrose generalized inverse.

As will be described below, the DUDE applies clean symbol count estimation on a per-context basis to obtain estimated counts of clean symbols occurring in particular noisy symbol contexts. The actual denoising of a noisy symbol is then determined from the noisy symbol's value, the resulting estimated context-dependent clean symbol counts, and a loss or distortion measure, in a manner described below.

As discussed above, the DUDE considers each symbol in a noisy signal within a context. The context may be, in a 1-dimensional signal, such as that used for the example of FIG. 1, the values of a number of symbols preceding, following, or both preceding and following a currently considered signal. In 2-dimensional or higher dimensional signals, the context may be values of symbols in any of an almost limitless number of different types of neighborhoods surrounding a particular symbol. For example, in a 2-dimensional image, the context may be the eight pixel values surrounding a particular, interior pixel. In the following discussion, a 1-dimensional signal is used for examples, but higher dimensional signals can be effectively denoised by the DUDE.

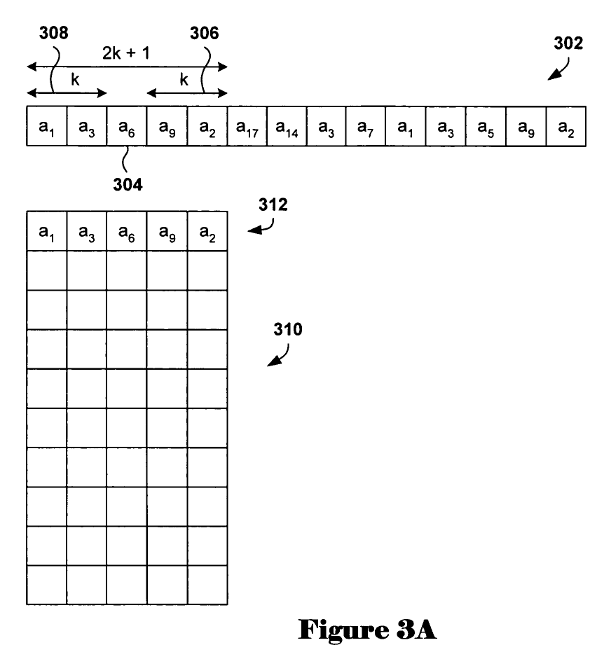

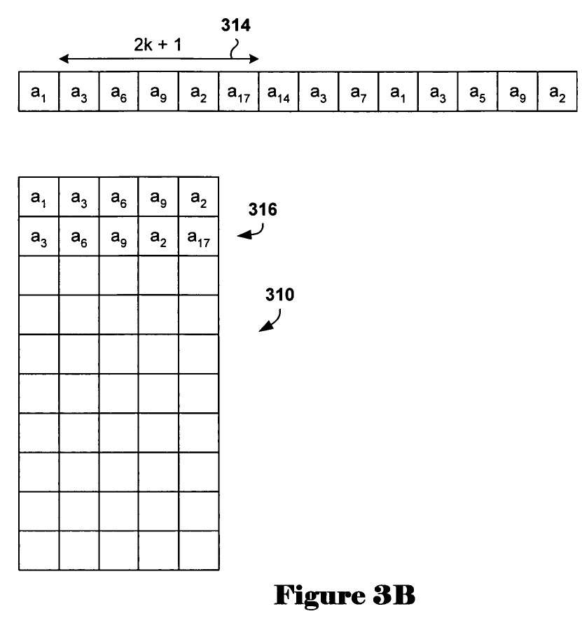

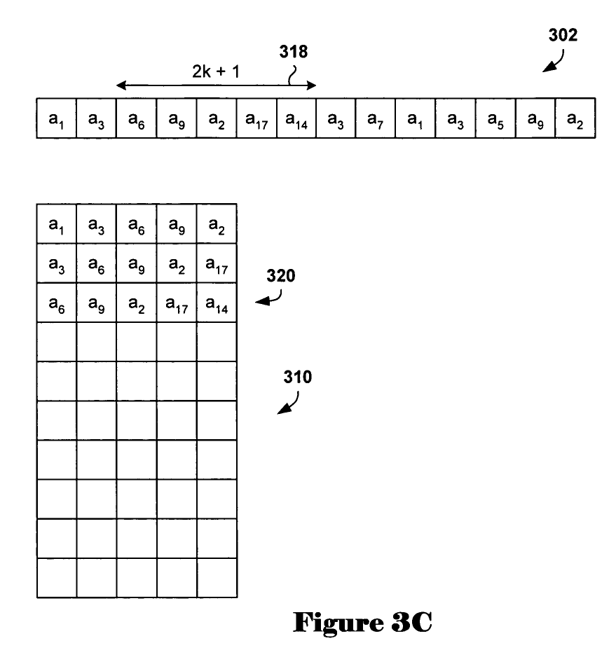

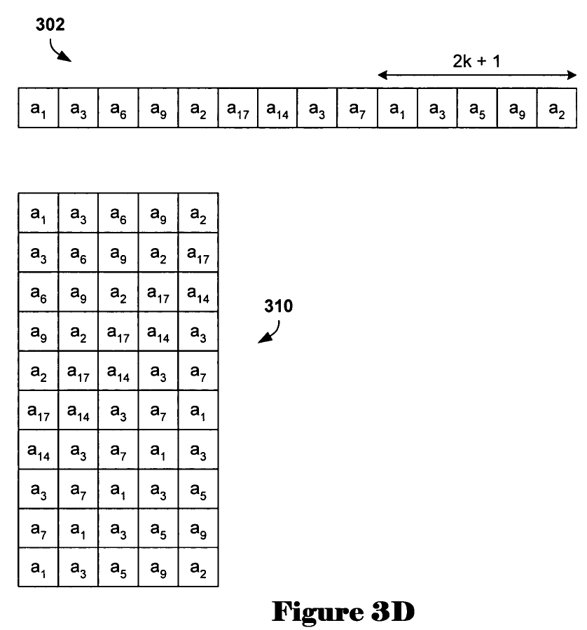

In order to consider occurrences of symbols within contexts in the 1-dimensional-signal case, the DUDE needs to consider a number of symbols adjacent to each, considered symbol. FIGS. 3A-D illustrate a context-based, sliding window approach by which the DUDE characterizes the occurrences of symbols in a noisy signal. FIGS. 3A-D all employ the same illustration conventions, which are described only for FIG. 3A, in the interest of brevity. In FIG. 3A, a noisy signal 302 is analyzed by DUDE in order to determine the occurrence counts of particular symbols within particular contexts within the noisy signal. The DUDE employs a constant k to describe the length of a sequence of symbols preceding, and the length of a sequence of symbols subsequent to, a particular symbol that, together with the particular symbol, may be viewed as a metasymbol of length 2k+1. In the example of FIGS. 3A-D, k has the value “2.” Thus, a symbol preceded by a pair of symbols and succeeded by a pair of symbols can be viewed as a five-symbol metasymbol. In FIG. 3A, the symbol “a₆” 304 occurs within a context of the succeeding k-length symbol string “a₉a₂” 306 and is preceded by the two-symbol string “a₁a₃” 308. The symbol “a₆” therefore occurs at least once in the noisy signal within the context [“a₁a₃,” “a₉a₂”], or, in other words, the metasymbol “a₁a₃a₆a₉a₂” occurs at least once in the noisy signal. The occurrence of this metasymbol within the noisy signal 302 is listed within a table 310 as the first five-symbol metacharacter 312.

As shown in FIG. 3B, DUDE then slides the window of length 2k+1 rightward, by one symbol, to consider a second metasymbol 314 of length 2k+1. In this second metasymbol, the symbol “a₉” appears within the context [“a₃a₆,” “a₂a₁₇”]. This second metasymbol is entered into table 310 as the second entry 316. FIG. 3C shows detection of a third metasymbol 318 in the noisy signal 302 and entry of the third metasymbol into table 310 as entry 320. FIG. 3D shows the table 310 following complete analysis of the short noisy signal 302 by DUDE. Although, in the examples shown in FIG. 3-D, DUDE lists each metasymbol as a separate entry in the table, in a more efficient implementation, DUDE enters each detected metasymbol only once in an index table, and increments an occurrence count each time the metasymbol is subsequently detected. In this fashion, in a first pass, DUDE tabulates the frequency of occurrence of metasymbols within the noisy signal or, viewed differently, DUDE tabulates the occurrence frequency of symbols within contexts comprising k preceding and k subsequent symbols surrounding each symbol.

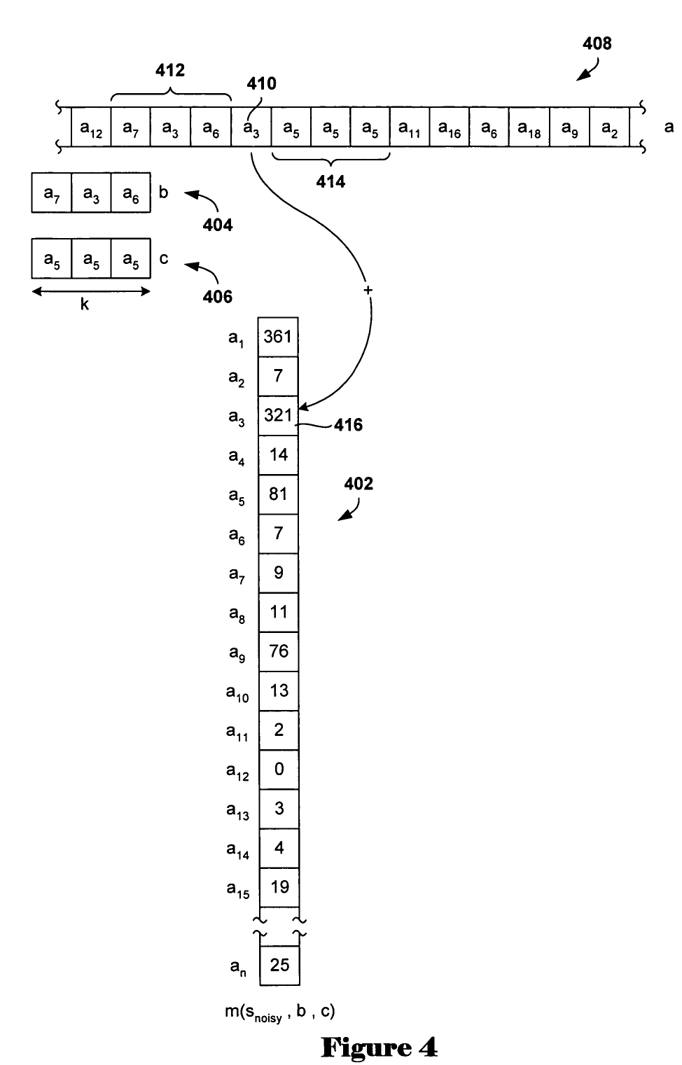

FIG. 4 illustrates a convenient mathematical notation and data structure representing a portion of the metasymbol table constructed by DUDE, as described with reference to FIGS. 3A-D. The column vector m(s_{noisy},b,c) 402 represents a count of the occurrences of each symbol in the alphabet A within a particular context, represented by the k-length symbol vectors b and c, within the noisy signal s_{noisy}, where the noisy signal is viewed as a vector. In FIG. 4, for example, the context value for which the occurrence counts are tabulated in column vector m(s_{noisy},b,c) comprises the symbol vector 404 and the symbol vector 406, where k has the value 3. In the noisy signal s_{noisy} 408, the symbol “a₃” 410 occurs within the context comprising three symbols 412 to the left of the symbol “a₃” 410 and three symbols 414 to the right of the symbol “a₃”. This particular context has a value equal to the combined values of symbol vectors 404 and 406, denoted [“a₇a₃a₆,” “a₅a₅a₅”] and this occurrence of the symbol “a₃” 410 within the context [“a₇a₃a₆,” “a₅a₅a₅”], along with all other occurrences of the symbol “a₃” in the context [“a₇a₃a₆,” “a₅a₅a₅”], is noted by a count 416 within the column vector m(s_{noisy},b,c), with [b,c]=[“a₇a₃a₆,” “a₅a₅a₅”]. In other words, a symbol “a₃” occurs within the context [“a₇a₃a₆,” “a₅a₅a₅”] in the noisy signal s_{noisy} 321 times. The counts for the occurrences of all other symbols “a₁”, “a₂”, and “a₄”-“aₙ” in the context [“a₇a₃a₆,” “a₅a₅a₅”] within noisy signal s_{noisy} are recorded in successive elements of the column vector m(s_{noisy}, “a₇a₃a₆”, “a₅a₅a₅”). An individual count within a column vector m(s_{noisy},b,c) can be referred to using an array-like notation. For example, the count of the number of times that the symbol “a₃” appears in the context [“a₇a₃a₆,” “a₅a₅a₅”] within the noisy signal s_{noisy}, 321, can be referred to as m(s_{noisy}, “a₇a₃a₆”, “a₅a₅a₅”)[a₃].

DUDE employs either a full or a partial set of column vectors for all detected contexts of a fixed length 2k in the noisy signal in order to denoise the noisy signal. Note that an initial set of symbols at the beginning and end of the noisy signal of length k are not counted in any column vector m(s_{noisy},b,c) because they lack either sufficient preceding or subsequent symbols to form a metasymbol of length 2k+1. However, as the length of the noisy signal for practical problems tends to be quite large, and the context length k tends to be relatively small, DUDE's failure to consider the first and final k symbols with respect to their occurrence within contexts makes almost no practical difference in the outcome of the denoising operation.

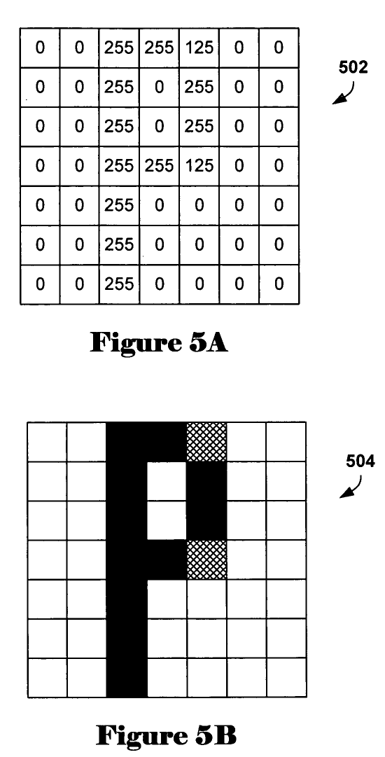

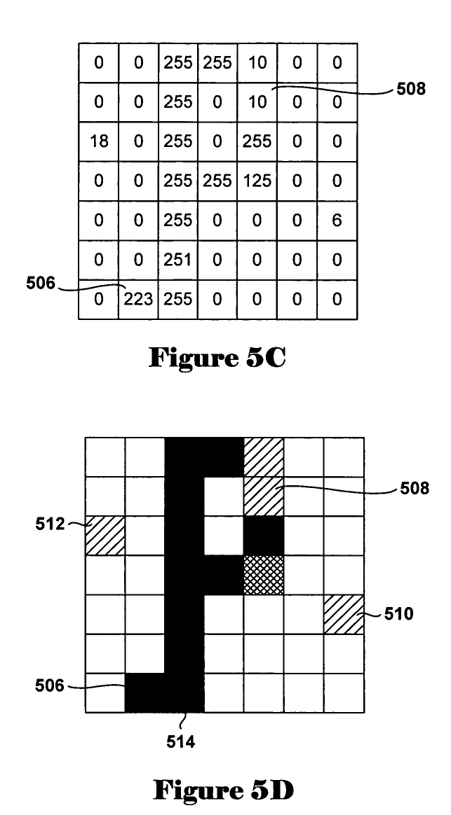

FIGS. 5A-D illustrate the concept of symbol-corruption-related distortion in a noisy or recovered signal. The example of FIGS. 5A-D relates to a 256-value gray scale image of a letter. In FIG. 5A, the gray-scale values for cells, or pixels, within a two-dimensional image 502 are shown, with the character portions of the symbol generally having a maximum gray-scale value of 255 and the background pixels having a minimum gray-scale value of zero, using a convention that the displayed darkness of the pixel increases with increasing numerical value. Visual display of the image represented by the two-dimensional gray-scale signal in FIG. 5A is shown in FIG. 5B 504. The gray-scale data in FIG. 5A is meant to represent a low resolution image of the letter “P.” As shown in FIG. 5B, the image of the letter “P” is reasonably distinct, with reasonably high contrast.

FIG. 5C shows the gray-scale data with noise introduced by transmission through a hypothetical noise-introducing channel. Comparison of FIG. 5C to FIG. 5A shows that there is marked difference between the gray-scale values of certain cells, such as cell 506, prior to, and after, transmission. FIG. 5D shows a display of the gray-scale data shown in FIG. 5C. The displayed image is no longer recognizable as the letter “P.” In particular, two cells contribute greatly to the distortion of the figure: (1) cell 506, changed in transmission from the gray-scale value “0” to the gray-scale value “223”; and (2) cell 508, changed in transmission from the gray-scale value “255” to the gray-scale value “10.” Other noise, such as the relatively small magnitude gray-scale changes of cells 510 and 512, introduce relatively little distortion, and, by themselves, would have not seriously impacted recognition of the letter “P.” In this case, the distortion of the displayed image contributed by noise introduced into the gray-scale data appears to be proportional to the magnitude of change in the gray-scale value. Thus, the distorting effects of noise within symbols of a signal are not necessarily uniform. A noise-induced change of a transmitted symbol to a closely related, received symbol may produce far less distortion than a noise-induced change of a transmitted symbol to a very different, received symbol.

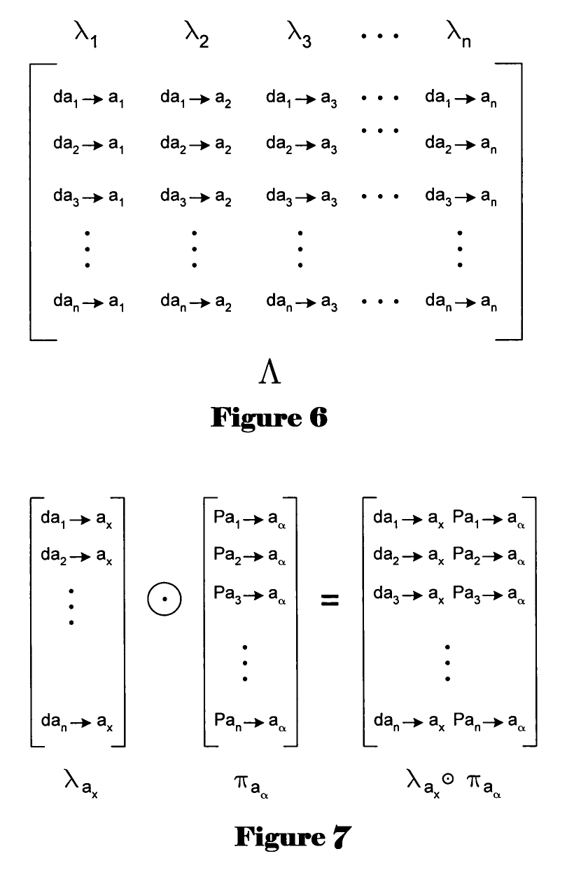

The DUDE models the non-uniform distortion effects of particular symbol transitions induced by noise with a matrix Λ. FIG. 6 displays one form of the symbol-transformation distortion matrix Λ. An element dₐ_{ᵢ}_{→a}_{ⱼ} of the matrix Λ provides the relative distortion incurred by substituting the symbol “aⱼ” in the noisy or recovered signal for the symbol “aᵢ” in the clean signal. An individual column j of the matrix Λmay be referred to as λⱼ or λₐ_{ⱼ}.

FIG. 7 illustrates computation of the relative distortion, with respect to the clean signal, expected from replacing a symbol “aₐ” in a received, noisy signal by the symbol “aₓ.” As shown in FIG. 7, element-by-element multiplication of the elements of the column vectors λₐ_{ₓ} and πₐ_{ₐ}, an operation known as the Shur product of two vectors, and designated in the current discussion by the symbol □, produces the column vector λₐ_{ₓ}□πₐ_{ₐ} in which the i-th element is the product of a distortion and probability, dₐ_{ᵢ}_{→a}_{ₓ}pₐ_{ᵢ}_{→a}_{ₐ}, reflective of the relative distortion expected in the recovered signal by replacing the symbol aₐ in the noisy symbol by the symbol “aₓ” when the symbol in the originally transmitted, clean signal is “aᵢ.”

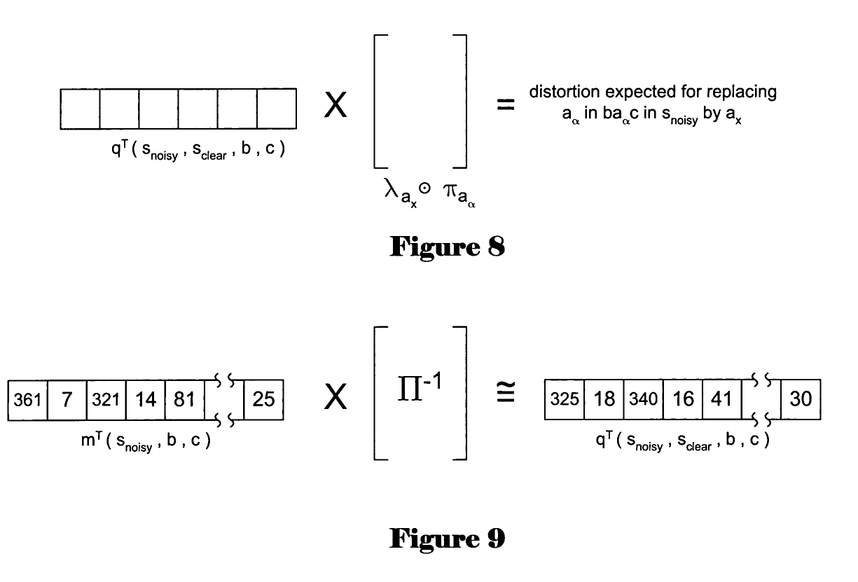

FIG. 8 illustrates use of the column vector λₐ_{ₓ}□πₐ_{ₐ} to compute a distortion expected for replacing “aₐ” in the metasymbol baₐc in a noisy signal s_{noisy} by the replacement symbol “aₓ”. In the following expression, and in subsequent expressions, the vectors s_{noisy} and s_{clean} denote noisy and clean signals, respectively. A different column vector q can be defined to represent the occurrence counts for all symbols in the clean signal that appear at locations in the clean signal that correspond to locations in the noisy signal around which a particular context [b, c] occurs. An element of the column vector q is defined as:
q(s_{noisy},s_{clean},b,c)[aₐ]=|{i:s_{clean}[i]=aₐ,(s_{noisy}[i−k],s_{noisy}[i−k+1], . . . , s_{noisy}[i−1])=b, (s_{noisy}[i+1], s_{noisy}[i+2], . . . , s_{noisy}[i+k])=c}|,
where s_{clean}[i] and s_{noisy}[i] denote the symbols at location i in the clean and noisy signals, respectively; and
aₐ is a symbol in the alphabet A.
The column vector q(s_{noisy},s_{clean},b,c) includes n elements with indices aₐ from “a₁” to “aₙ” where n is the size of the symbol alphabet A. Note that the column vector q(s_{noisy},s_{clean},b,c) is, in general, not obtainable, because the clean signal, upon which the definition depends, is unavailable. Multiplication of the transpose of the column vector q(s_{noisy},s_{clean},b,c), q^{T}(s_{noisy},s_{clean},b,c), by the column vector λₐ_{ₓ}□πₐ_{ₐ} produces the sum of the expected distortions in the column vector times the occurrence counts in the row vector that together provide a total expected distortion for replacing “aₐ” in the metasymbol baₐc in s_{noisy} by “aₓ”. For example, the first term in the sum is produced by multiplication of the first elements in the row vector by the first element in the column vector, resulting in the first term in the sum being equal to q^{T}(s_{noisy},s_{clean},b,c)[a₁](pₐ_{₁}_{→a}_{ₐ}dₐ_{₁}_{→a}_{ₓ}) or, in other words, a contribution to the total distortion expected for replacing “aₐ” by “aₓ” in all occurrences of baₐc in s_{noisy} when the corresponding symbol in s_{clean} is a₁. The full sum gives the full expected distortion:

$$\begin{matrix}{q}^{T} ( {s}_{noisy} , {s}_{clean} , b , c ) [ {a}_{1} ] ( {p}_{{a}_{1} -> {a}_{α}} {d}_{{a}_{1} -> {a}_{x}} ) + \\ {q}^{T} ( {s}_{noisy} , {s}_{clean} , b , c ) [ {a}_{2} ] ( {p}_{{a}_{2} -> {a}_{α}} {d}_{{a}_{2} -> {a}_{x}} ) + \\ {q}^{T} ( {s}_{noisy} , {s}_{clean} , b , c ) [ {a}_{3} ] ( {p}_{{a}_{3} -> {a}_{α}} {d}_{{a}_{3} -> {a}_{x}} ) + \\ . \\ . \\ . \\ {q}^{T} ( {s}_{noisy} , {s}_{clean} , b , c ) [ {a}_{n} ] ( {p}_{{a}_{n} -> {a}_{α}} {d}_{{a}_{n} -> {a}_{x}} )\end{matrix}$$

As discussed above, DUDE does not have the advantage of knowing the particular clean signal, transmitted through the noise-introducing channel that produced the received noisy signal. Therefore, DUDE estimates the occurrence counts, q^{T}(s_{noisy},s_{clean},b,c) of symbols in the originally transmitted, clean signal, by multiplying the row vector m^{T}(s_{noisy},b,c) by Π⁻¹ from the right. FIG. 9 shows estimation of the counts of the occurrences of symbols “a₁”-“aₙ” for the clean signal.

The resulting expression
m^{T}(s_{noisy},b,c)Π⁻¹(λₐ_{ₓ}□πₐ_{ₐ})
obtained by substituting m^{T}(s_{noisy},b,c) Π⁻¹ for q^{T}(s_{noisy},s_{clean},b,c) represents DUDE's estimation of the distortion, with respect to the originally transmitted clean signal, produced by substituting “aₓ” for the symbol “aₐ” within the context [b, c] in the noisy signal s_{noisy}. DUDE denoises the noisy signal by replacing “aₐ” in each occurrence of the metasymbol baₐc by that symbol “aₓ” providing the least estimated distortion of the recovered signal with respect to the originally transmitted, clean signal, using the above expression. In other words, for each metasymbol baₐc, DUDE employs the following transfer function to determine how to replace the central symbol aₐ:

$${g}_{a}^{k} ( b , {a}_{α} , c ) = \frac{arg min}{{a}_{x} = {a}_{1} to {a}_{n}} [ {m}^{T} ( {s}_{noisy} , b , c ) {Π}^{- 1} ( {λ}_{{a}_{x}} • {π}_{{a}_{α}} ) ]$$

In some cases, the minimum distortion is produced by no substitution or, in other words, by the substitution aₓ equal to aₐ.

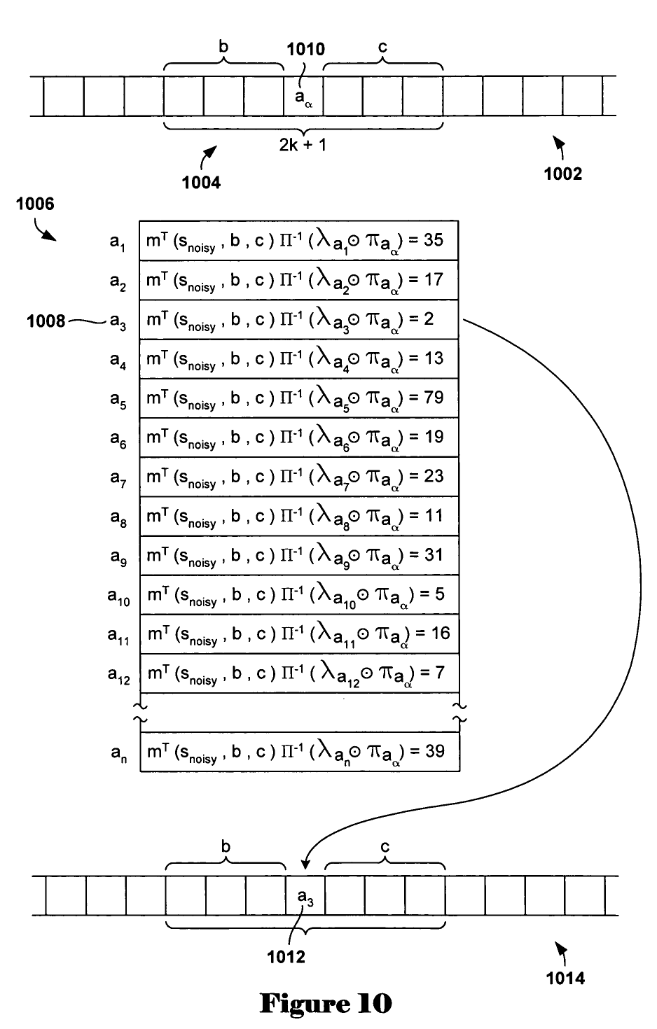

FIG. 10 illustrates the process by which DUDE denoises a noisy, received signal. First, as discussed above, DUDE compiles counts for all or a portion of the possible metasymbols comprising each possible symbol “aᵢ” within each possible context [b, c]. As discussed above, the counts are stored in column vectors m(s_{noisy},b,c). In the next pass, DUDE again passes a sliding window over the noisy signal 1002. For each metasymbol, such as metasymbol 1004, DUDE determines the relative distortions of the recovered signal with respect to the clean signal that would be produced by substituting for the central character of the metasymbol “aₐ” each possible replacement symbol “aᵢ” in the range i=1 to n. These relative distortions are shown in table 1006 in FIG. 10 for the metasymbol 1004 detected in the noisy signal 1002. Examining the relative distortion table 1006, DUDE selects the replacement symbol with the lowest relative distortion, or, in the case that two or more symbols produce the same relative distortions, selects the first of the multiple replacement symbols with the lowest estimated distortion. In the example shown in FIG. 10, that symbol is “a₃” 1008. DUDE then replaces the central symbol “aₐ” 1010 in the noisy signal with the selected replacement symbol “a₃” 1012 in the recovered signal 1014. Note that the recovered signal is generated from independent considerations of each type of metasymbol in the noisy signal, so that the replacement symbol selected in a previous step does not affect the choice for a replacement symbol in a next step for a different metasymbol. In other words, the replacement signal is generated in parallel, rather than substitution of symbols directly into the noisy signal. As with any general method, the above-described method by which DUDE denoises a noisy signal can be implemented using various data structures, indexing techniques, and algorithms to produce a denoising method that has both linear time and linear working-data-set complexities or, in other words, the time complexity is related to the length of the received, noisy signal, by multiplication by a constant, as is the working-data-set complexity.

The examples employed in the above discussion of DUDE are primarily 1-dimensional signals. However, as also discussed above, 2-dimensional and multi-dimensional signals may also be denoised by DUDE. In the 2-and-multi-dimensional cases, rather than considering symbols within a 1-dimensional context, symbols may be considered within a contextual neighborhood. The pixels adjacent to a currently considered pixel in a 2-dimensional image may together comprise the contextual neighborhood for the currently considered symbol, or, equivalently, the values of a currently considered pixel and adjacent pixels may together comprise a 2-dimensional metasymbol. In a more general treatment, the expression m^{T}(s_{noisy},b,c)Π⁻¹(λₐ_{ₓ}□πₐ_{ₐ}) may be replaced by the more general expression:
m^{T}(s_{noisy},η)Π⁻¹(λₐ_{ₓ}□πₐ_{ₐ})
where η denotes the values of a particular contextual neighborhood of symbols. The neighborhood may be arbitrarily defined according to various criteria, including proximity in time, proximity in display or representation, or according to any arbitrary, computable metric, and may have various different types of symmetry. For example, in the above-discussed 1-dimensional-signal examples, symmetric contexts comprising an equal number of symbols k preceding and following a currently considered symbol compose the neighborhood for the currently considered symbol, but, in other cases, a different number of preceding and following symbols may be used for the context, or symbols either only preceding or following a current considered symbol may be used.

### Biopolymer Sequences

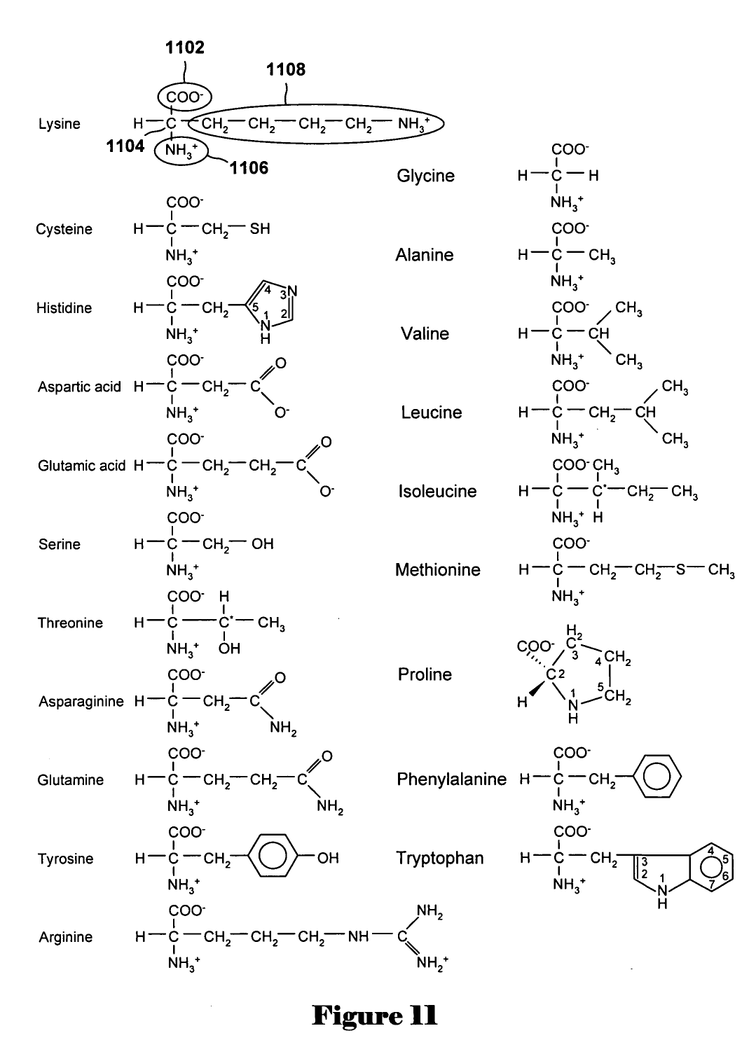

FIG. 11 shows the chemical structures of the 20 commonly occurring amino acids. Each amino acid can be described as having an alpha-carboxyl group 1102, an alpha carbon 1104, an alpha-amino group 1106, and an R group or side chain 1108. The particular, characteristic properties of different amino acids within amino-acid polymers, referred to as “polypeptides” or “proteins,” are conferred by the chemistry of the side chains. Certain side chains contain charged moieties, such as the side chains of arginine, aspartic acid, glutamic acid, and lysine, other side chains are highly hydrophobic, including the side chains of leucine, isoleucine, valine, and phenylalanine. Those amino acids having charged side chains can be further divided into those with positively charged side chains, such as lysine and arginine, and those with negatively charged side chains, such as aspartic acid and glutamic acid. Other amino acids contain side chains with reasonably efficient nucleophyles, such as serine and histidine that commonly occur in active sites in which substrates of enzymes are chemically modified.

Amino acids are chemically joined together, or polymerized, by a series of condensation reactions involving the alpha-carboxyl group of one amino acid or polypeptide and the alpha-amino group of a second amino acid to form dipeptides, tripeptides, and larger polymers up to and including protein polymers containing thousands of amino-acid subunits. FIG. 12 illustrates a four-amino-acid peptide 1202, including an alanine subunit 1204, a tyrosine subunit 1206, an aspartic acid subunit 1208, and a glycine subunit 1210. An amino-acid polymer, such as a polypeptide or protein, has a free alpha-amino end 1212 and a free alpha-carboxyl end 1214.

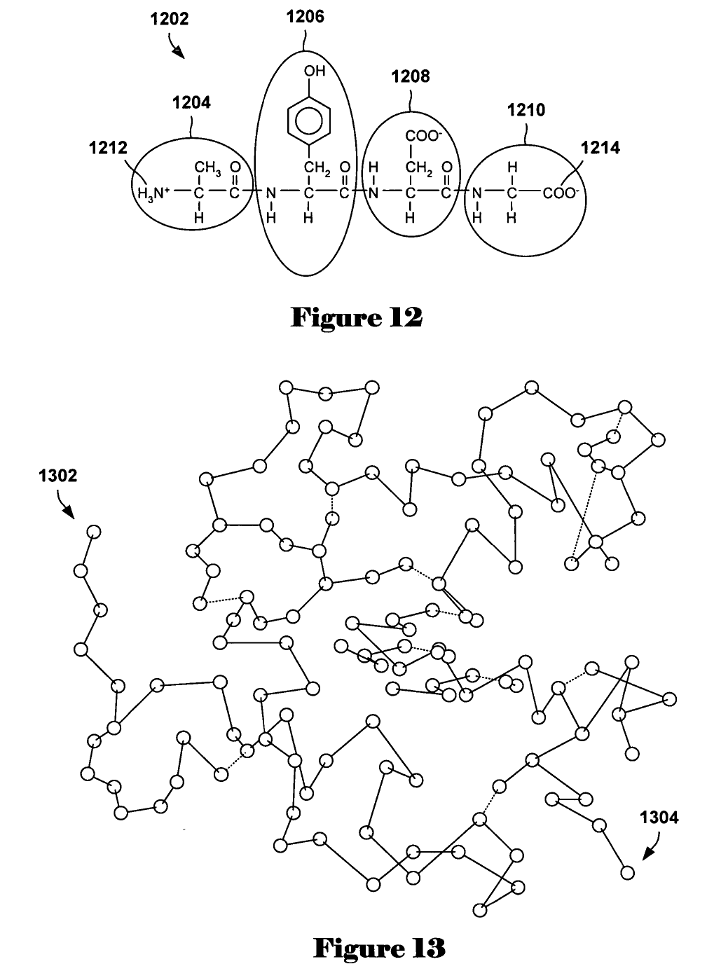

FIG. 13 shows a ball-and-stick representation of the structure of a typical protein. As with a polypeptide, the protein has an amino end 1302 and a carboxyl end 1304. Proteins have characteristic three-dimensional confirmations that represent thermodynamically stable confirmations in solution, determined by the amino-acid sequence of the protein polymer as well as by the properties of concentrated aqueous solutions. The biological function of proteins is, in turn, determined both by the three-dimensional confirmation of the protein as well as by the spatial arrangement of particular functional groups, particularly amino-acid side chains, within small, active-site regions of catalytic proteins. While many proteins are enzymes which catalyze chemical reactions, other important types of proteins include proteins that serve as structural scaffolding for biological tissues, regulators of gene transcription, signal molecules, pigments, carriers of small molecules, and myriad other functions.

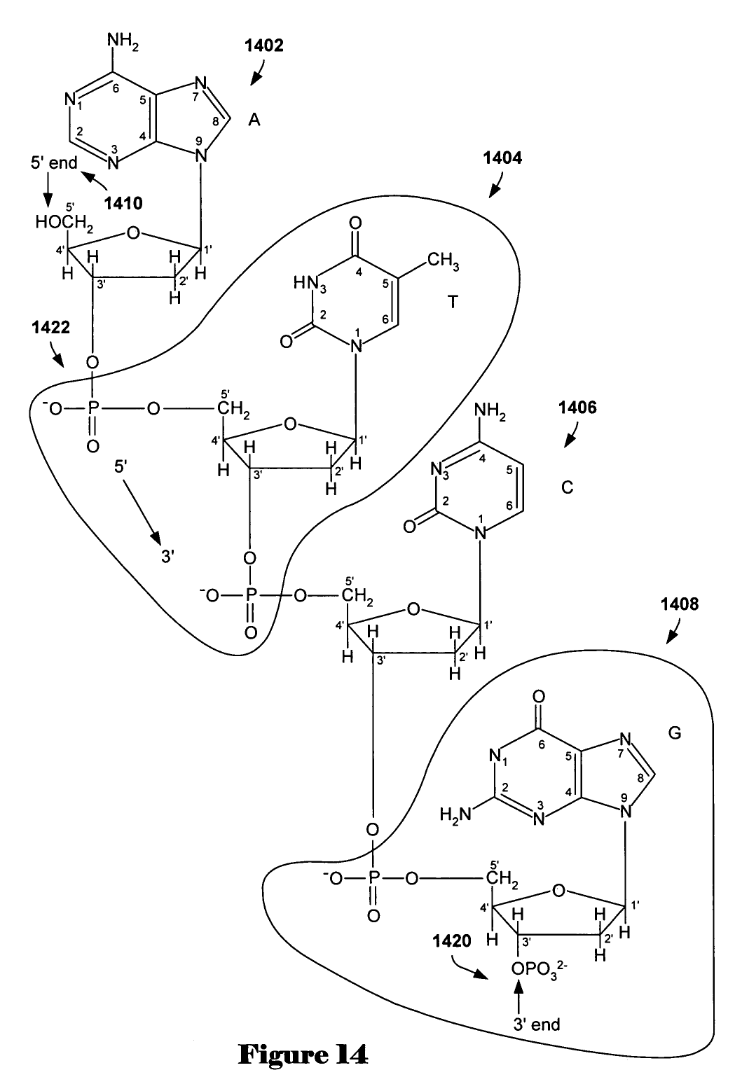

Deoxyribonucleic acid (“DNA”) is the primary information-storage biopolymer in organisms. The subunits of DNA are deoxynucleotides. FIG. 14 shows a four-deoxynucleotide DNA polymer containing one of each of the commonly occurring deoxynucleotide monomers. The commonly occurring deoxynucleotide monomers include adenosine 1402, thymine 1404, cytodine 1406, and guanocine 1408. These monomers are commonly abbreviated, in biopolymer sequence listings, as “A,” “T,” “C,” and “G,” respectively. A DNA polymer has a 5′ end 1410 and a 3′ end 1420, referring to the number of the carbon in the deoxyribose portion of the deoxynucleotide that contains a free hydroxyl or phosphate group involved in bonding with an adjoining nucleotide. The nucleotides are linked together through phosphate bridges, such as phosphate 1422. Each different type of nucleotide includes a distinct purine base, in the case of adenosine and guanocine, or pyrymidine base, in the case of thymine and cytodine.

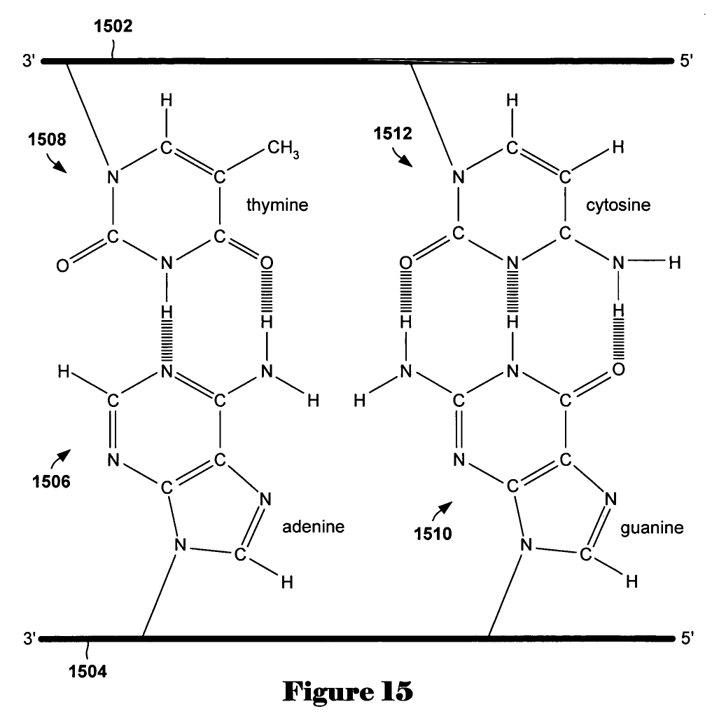

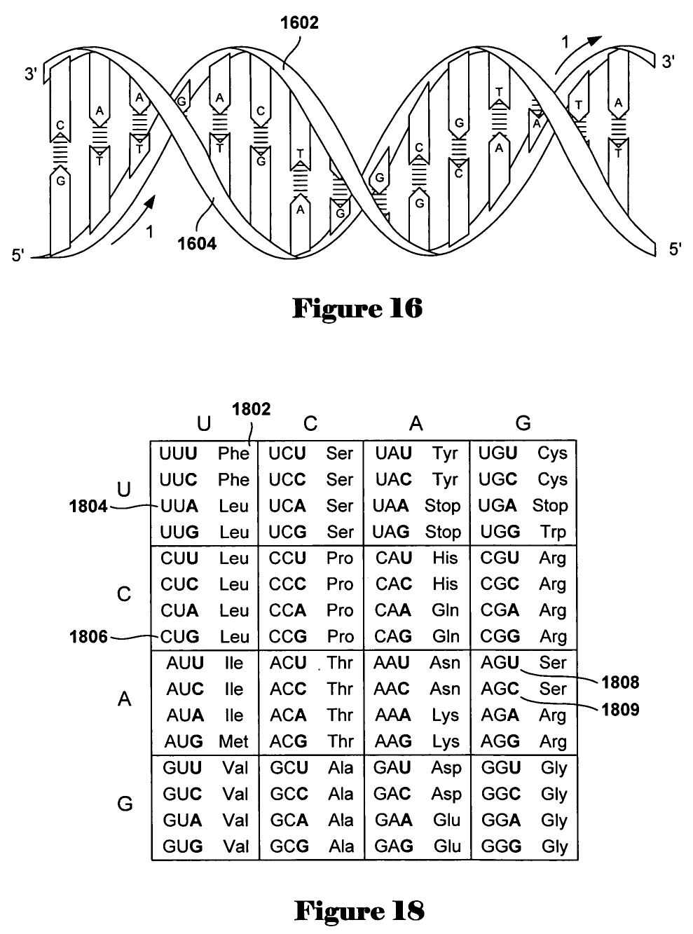

In chromosomes, two distinct, anti-parallel DNA polymers are complexed together through non-covalent bonding and other non-covalent interactions to form a double-stranded DNA polymer. FIG. 15 illustrates hydrogen bonding that occurs between complementary bases of complementary nucleotides within a double-stranded DNA polymer. The deoxyribose/phosphate backbone chains of the two anti-parallel, single-stranded DNA polymers are shown as heavy black lines 1502 and 1504. The adenine base of an adenosine deoxynucleotide 1506 of one single-stranded polymer hydrogen bonds to the thymine base 1508 of a complementary deoxynucleotide subunit of the other single-stranded DNA polymer. Similarly, a guanine base 1510 may hydrogen bond with a cytosine base 1512 contributed from the opposite single-stranded DNA. FIG. 16 shows the familiar double-helix confirmation of a double-stranded DNA polymer. The sugar/phosphate backbones of each single-stranded DNA polymer 1602 and 1604 form anti-parallel, intertwined helices, with the paired bases of complementary nucleotide subunits approximately orthogonal to the axis of the double helix. As shown in FIG. 16, any of the nucleotides “A,” “T,” “G,” and “C” can occur in either strand, with a constraint that an “A” nucleotide on one strand needs to be complementary to a “T” nucleotide on the other strand, and a “G” nucleotide on one strand needs to be complementary to a “C” nucleotide on the other strand. Mismatched based pairings lead to instabilities in the double helix confirmation, and are recognized, excised, and repaired by elaborate DNA repair mechanisms within living organisms. The genetic code is simply the sequence of “A,” “T,” “G,” and “C” bases along either of the single strands of a double-stranded DNA molecule. Because the bases are strictly complementary, as discussed above, the sequence of a second single strand within a double-stranded DNA molecule is fully determined by the sequence of a first strand, and vice-versa.

In general, particularly in higher organisms, a gene is a subsequence of the nucleotide sequence of one strand of a double-stranded DNA biopolymer. In any particular chromosome, genes may be distributed between the two different single-stranded molecules within the double-stranded DNA polymer, but a gene on a first strand generally does not overlap a gene on a second strand. However, there may be many alternative splicings of the mRNA product of the deoxynucleotide sequence within a gene that encode many different variant proteins.

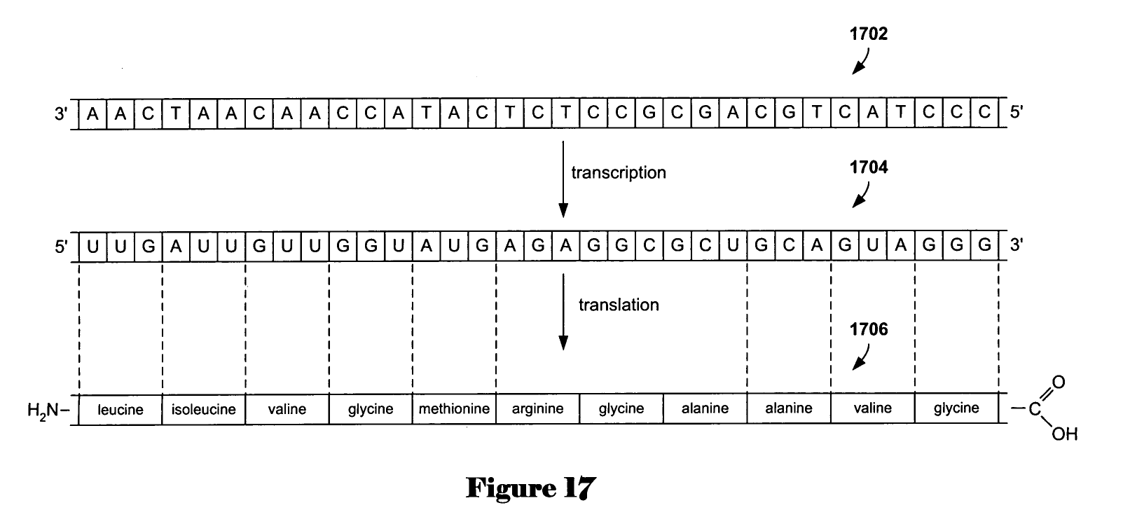

The nucleotide sequence in a DNA polymer encodes information in various different codes. Genes are nucleotide subsequences that encode the amino-acid sequence of proteins. However, a DNA polymer may contain many other types of information, including direct encodings of the sequences of ribonucleic acid (“RNA”) molecules, and encoded recognition sites for various protein transcription modulators, such as promoters and inhibitors. FIG. 17 illustrates the process by which a gene sequence is decoded to produce the amino-acid sequence of a protein. The gene nucleotide sequence 1702 is first transcribed into an anti-parallel MRNA sequence 1704 by direct replication, with thymidine deoxynucleotides in the DNA sequence replaced by uridine nucleotides in the RNA sequence, and the mRNA sequence is then decoded into the amino acid sequence 1706 of a protein. Each nucleotide triplet within the nucleotide sequence encodes a single amino acid.

FIG. 18 shows a table for the encoding of amino acids by nucleotide triplets within an mRNA sequence. In table 18, each cell of the grid within the table, such as cell 1802, is identified by the first two nucleotides of a nucleotide triplet code. Each cell contains the four triplet codes formed from the first two nucleotides that index the cell and a third nucleotide selected from among the four RNA nucleotides “A,” “U,” “G,” and “C.” There are 43 or 64 different triplet codes shown in FIG. 18, but only 20 amino acids. The code is therefore highly redundant. For example, as can be seen in FIG. 18, there are six different triplet codes that code for the amino acid leucine, starting with code 1804 and ending with code 1806. Three codes are stop codes, or terminating codes analogous to periods in the English language. The highly redundant encoding shown in FIG. 18 arose through billions of years of evolutionary processes, and reflects optimization, by the evolutionary processes, of many divergent and competing forces and considerations. For example, the encoding should be as chemically efficient as possible, and is, since a triplet code is the smallest code using four-value symbols that can encode for the 20 different amino acids. The code needs to be reasonably tolerant of errors in the third nucleotide, since the translational machinery is less discriminating in the third nucleotide than in recognition of the first two nucleotides of a nucleotide triplet. As can be seen by perusing the table of FIG. 18, interchanging an “A” for a “G” or a “G” for an “A” in the third nucleotide of a nucleotide triplet, or interchanging a “C” for a “U” or a “U” for a “C,” generally produces an alternative encoding for the same amino acid. For example, interchanging the “U” that occurs in the first encoding 1808 for serine with a “C” produces the second, alternative encoding for serine 1809.

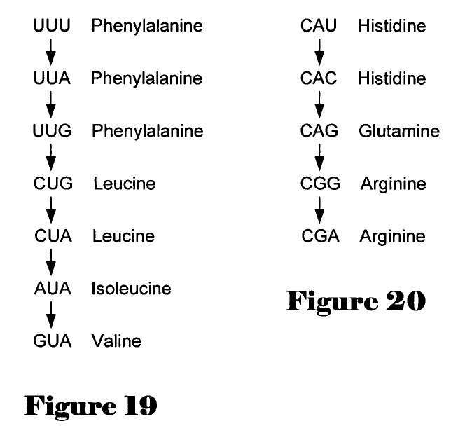

There are even more important redundancies in the nucleotide-triplet encoding for amino acids shown in the table of FIG. 18. As discussed above, the amino acid sequence of a protein largely dictates the protein's confirmation in solution which, in turn, dictates the protein's biological function and interactions with other biomolecules. As discussed above, the different amino acids fall into various categories that depend on the chemical characteristics of their side chains. For example, phenylalanine, leucine, isoleucine, and valine all have hydrophobic side chains, and tend to be positioned within the interior of proteins in the minimal energy confirmations found in solution. Replacement of one hydrophobic-side-chain-containing amino acid with another generally has only a small effect on the confirmation of a protein, while replacement of a hydrophobic-side-chain-containing amino acid with a polar-side-chain-containing amino acid may result in marked confirmational changes, since polar-side-chain-containing amino acids tend to reside at or near the surface of proteins in order for the polar-side chain to interact with water. Therefore, it would be desirable if single-nucleotide alterations of triplet codes for hydrophobic-side-chain-containing amino acids produced either alternative encodings for the amino acid or encodings for other, hydrophobic-chain-containing amino acids. FIG. 19 illustrates a series of single-nucleotide transformations of triplet codons, starting with the nucleotide code “UUU” for phenylalanine. As can be seen in FIG. 19, the entire series of single-nucleotide substitutions produces either alternative encodings for phenylalanine, or encodings for other, hydrophobic-side-chain-containing amino acids. Similarly, FIG. 20 shows a series of single-nucleotide substitutions starting with the triplet code for histidine “CAU.” As can be seen in FIG. 20, a series of single-nucleotide substitutions results in either an alternative encoding for histidine, or encodings for other amino acids having side chains containing nucleophylic nitrogen atoms. Therefore, there is a second, important resilience in the genetic code to deleterious effects of single-nucleotide changes. As is well known, single-nucleotide mutations in DNA double-stranded polymers are relatively frequent occurrences, and the resiliency in the genetic code helps to compensate for the instability of the underlying genetic code. Of course, that genetic-code instability also leads to the dynamic nature of the information content of organisms, and is the chief mechanism underlying evolutionary changes. While mutations may be deleterious for individual organisms, mutations are, in the long run, the mechanism that allows species to evolve in order to exploit their changing surroundings, and allows for new species to arise.

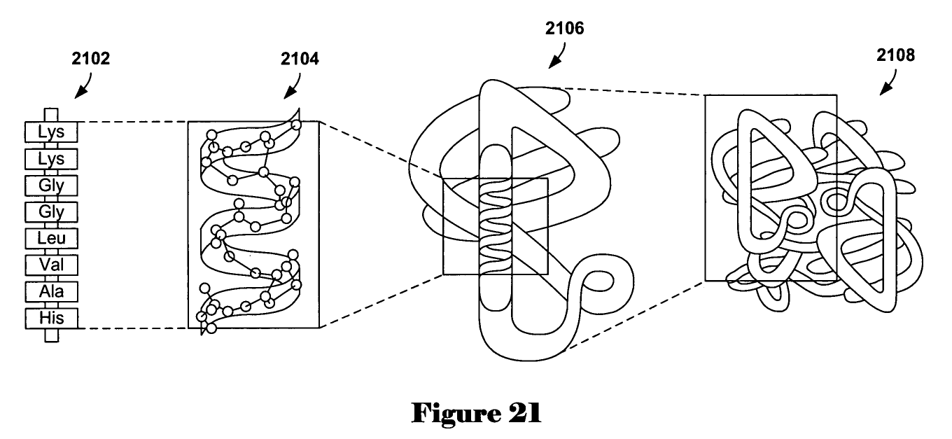

FIG. 21 illustrates the different levels of the implications of amino-acid sequences within proteins. As shown in FIG. 21, the amino-acid sequence 2102, referred to as the “primary structure,” largely determines various higher-level, secondary structures within proteins, such as regions of alpha helix 2104, which, along with distribution of hydrophobic versus hydrophilic amino acids, and other distributions, determine the overall confirmation, or tertiary structure 2106, of a protein or polypeptide chain. Individual amino-acid polymers may also self-assemble into more complex, multi-polymer aggregates 2108. Such macromolecular structures include many well-known proteins, including the oxygen-transport protein hemoglobin, various membrane-resident protein complexes that regulate transport of ions and chemical substances through cell membranes, virus-code proteins, many enzymes, and other such proteins. Therefore, there are higher levels of information contained within amino acid sequences of proteins, and therefore in the DNA polymers that encode them. For example, portions of amino-acid sequences are involved in protein-protein interaction and binding regions that hold macromolecular assemblies together. These sequences are no doubt also relatively resilient to mutations, so that a single mutation has a relatively low chance of producing a non-functional macromolecular assembly and, ultimately, a non-functional organism. Note that the binding sites, active sites, and other critical 3-dimensional regions in tertiary structure may involve particular side chains contributed by non-adjacent amino acids, so that a binding region may be encoded by subsequences of amino acids quite far from one another in the primary sequence.

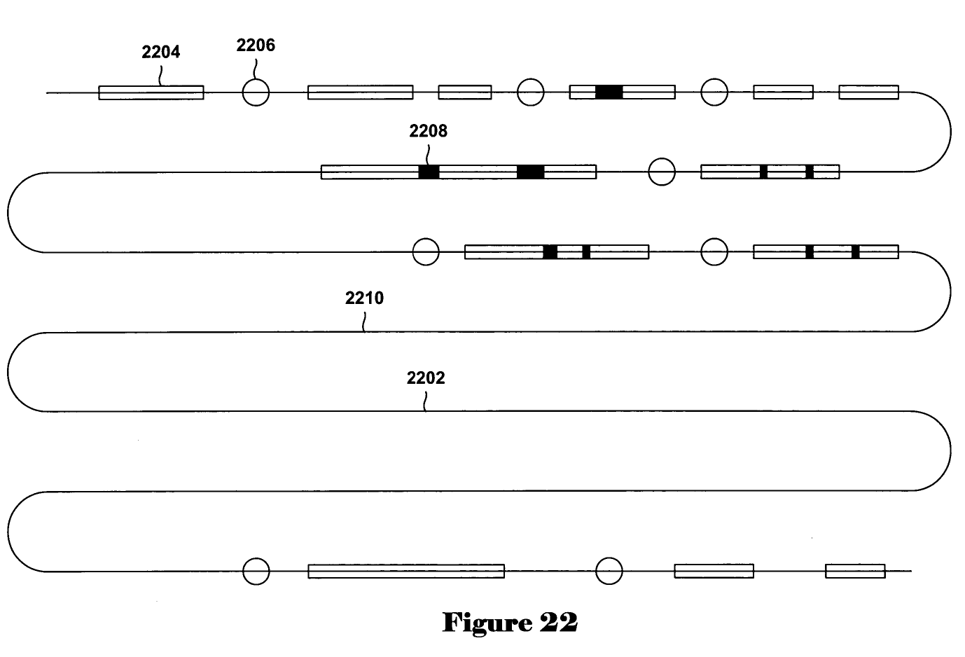

FIG. 22 illustrates a hypothetical portion of a chromosomal double-stranded DNA polymer. The double-stranded polymer is represented in FIG. 22 by the lengthy line 2202. Different types of subregions, or subsequences, within the double-stranded DNA polymer are indicated by additional markings. In the hypothetical example, for example, protein-encoding genes are illustrated by rectangular markings, such as marking 2204. Gene-transcription control subsequences are shown in FIG. 22 as circles, such as circle 2206. Gene-transcription subsequences are generally sequence-specific binding sites to which protein or RNA molecules bind to either activate a gene or to repress the gene. Additional control regions include sites to which the RNA polymerase complex binds in order to initiate transcription of genes. In many genes, there are subsequences, shown in FIG. 22 as darkened rectangular regions, such as region 2208, which are transcribed, but then excised from the mRNA transcription product. These regions, referred to as introns, may occasionally code for protein sequences, and may be spliced in or out of mRNA molecules in order to provide alternate transcription forms for a particular gene. In other cases, the introns are non-coding regions. In the exemplary DNA polymer shown in FIG. 22, there's a large, middle region 2210 without either transcription control regions or genes. Large sections of chromosomal DNA in many organisms do not encode proteins and are not involved in the transcription process. Historically, these regions were referred to as “junk DNA,” although the term has always been somewhat inappropriate, since evolutionary processes tend towards chemical efficiency. Information sciences research on DNA sequences has revealed that although many of these regions lack the dense information content of genes, they nonetheless are far from random, and may be involved in as yet undetermined informational roles within organisms. A portion of the non-coding regions of chromosomal DNA of higher organisms consists of very short, identical sequences that are repeated again and again over long stretches of the chromosomal DNA. The end portions of chromosomal DNA contain sequences known as telemeres that are involved in maintaining chromosomes over repeated cycles of replication, during cell division.

Each of the different types of subregions within chromosomal DNA is likely to have different types of information content and encoding, and markedly different resiliency to noise, or mutations. For example, as discussed above, protein-encoding genes need to have encodings highly resilient to mutations, so that point mutations do not result, with high probability, in defective protein products. As discussed above, there may be higher order resiliency to different patterns of change, related to sequences involved in protein-to-protein interactions and protein conformation. The transcription-control regions may also need to be resilient to mutations so that mutated control regions do not result in loss of, or constant, high production of particular genes. However, the resiliency is probably different than that in genes, because nucleotide-triplet encoding is not involved, but instead complex DNA-to-protein and RNA-to-DNA binding interactions are involved. Non-coding regions may include regions of relatively low redundancy that may be far less resilient to introduction of noise via mutations, while noise introduced in the regions of short, repetitive sequences may be far more easily recognized than in other sequences, because of the low entropy and predictability of the highly repetitious pattern. For example, the information content of a seemingly random sequence is approximately equivalent to the number of bits necessary to represent the sequence, while the information content of a long length of repeated, short sequences may be approximated by the number of bits needed to represent the short sequence, as well as the number of bits needed to represent an integer large enough to encode the number of repetitions of the short sequence.

### Methods that Employ a Denoiser to Analyze Biopolymer Sequences

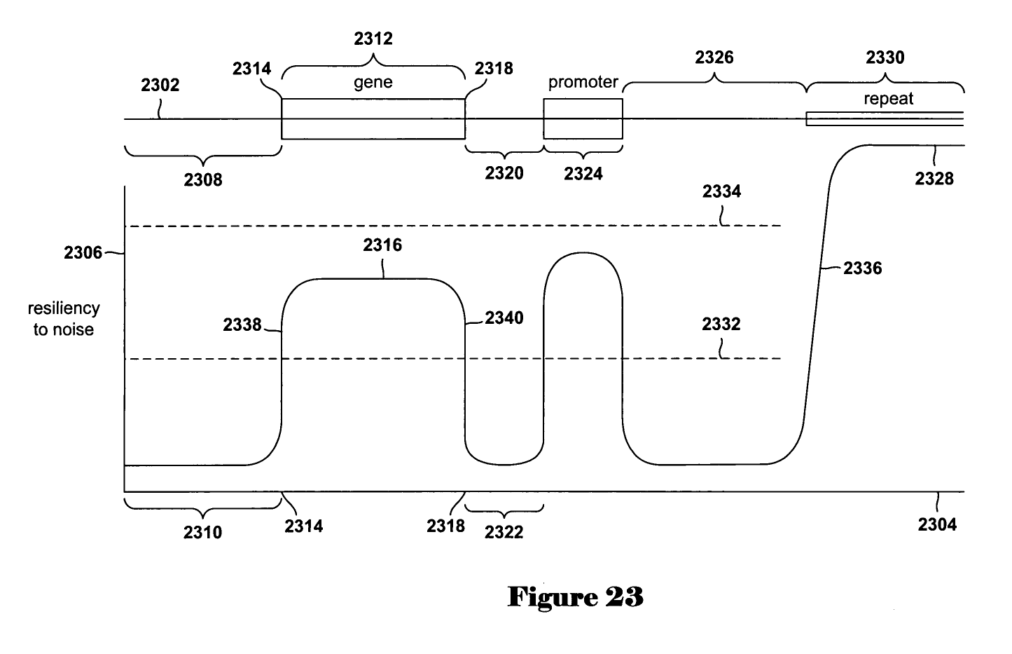

An underlying assumption motivating the present invention is that different subregions, or subsequences, within biopolymer sequences having different biological functions may store information with different resiliencies to noise. In the case of DNA polymers, the noise is generally chemical mutation events, including single-nucleotide mutations, subsequence deletions, subsequence insertions, and many other well-known mutational events. In all biopolymers, chemical changes may also occur by modification of subunits within the biopolymers following synthesis, such as methylation of cytidine in DNA and addition of phosphates, lipids, polysaccharides, and other chemical entities to proteins via enzyme catalysis. As discussed above, in a previous subsection, portions of biopolymers may redundantly encode information vital to survival of an organism, requiring high informational encoding resiliency, whereas other portions may be involved in less critical functions, and therefore may require a lower resiliency to noise and less redundancy in encoding. Also, there are many types of information encoding, each type of which may exhibit different levels of redundancy and noise tolerance. Resiliency is generally expensive, involving redundancy and chemical overhead. Because biopolymers have evolved over long periods of time within biological organisms under energy and chemical efficiency constraints, it is reasonable to assume that subsequences within biopolymers with different biological functions and different needs for resiliency to noise have evolved to achieve levels of resiliency that represent maximally efficient information storage under the constraints imposed by the functions of the subsequences or information stored within the subsequences. FIG. 23 graphically illustrates the above-described assumption that provides significant motivation for the present invention. A portion of a double-stranded DNA polymer 2302 is shown at the top of FIG. 23, aligned with the horizontal axis 2304 of a graph plotting the resiliency to noise, on they axis 2306 versus the position within the DNA polymer 2302 along the x axis 2304. In a first region of the DNA polymer 2308, the level of resiliency to noise 2310 is relatively low, corresponding to non-encoding, but not highly repetitive DNA sequence preceding a gene 2312. At the position of the non-coding-DNA gene boundary 2314, the resiliency to noise within the DNA polymer sequence dramatically rises to a relatively high level 2316 corresponding to the relatively high redundancy of nucleotide-triplet encoding within the gene. At the boundary between the gene 2318 and a subsequent, non-encoding subsequence 2320, the resiliency to noise dramatically falls 2322, rising again in the subsequence corresponding to a promoter 2324. The resiliency to noise falls to a low value for a subsequent non-encoding region 2326, but then rises to a very high level 2328 within a repetitive region 2330 consisting of a short nucleotide sequence repeated over and over again. The graph of resiliency to noise versus position within the DNA polymer sequence thus exhibits two primary characteristics. First, the level of resiliency to noise, as plotted with respect to the y axis 2306, is indicative of the type of subsequence within the DNA polymer at that location, with non-repetitive, non-encoding subsequences falling well below a first level of resiliency to noise 2332, the resiliency to noise of coding regions and transcription-control regions falling between a second resiliency-to-noise level 2334, and the first level 2332, and the resiliency to noise of a highly repetitive region falling above the second level 2334. In addition, steeply sloped sections of the resiliency-to-noise versus position curve 2336, such as the steeply ascending section 2338 and the steeply descending section 2340, are indicative of boundaries between subsequences of different types, or functionalities.

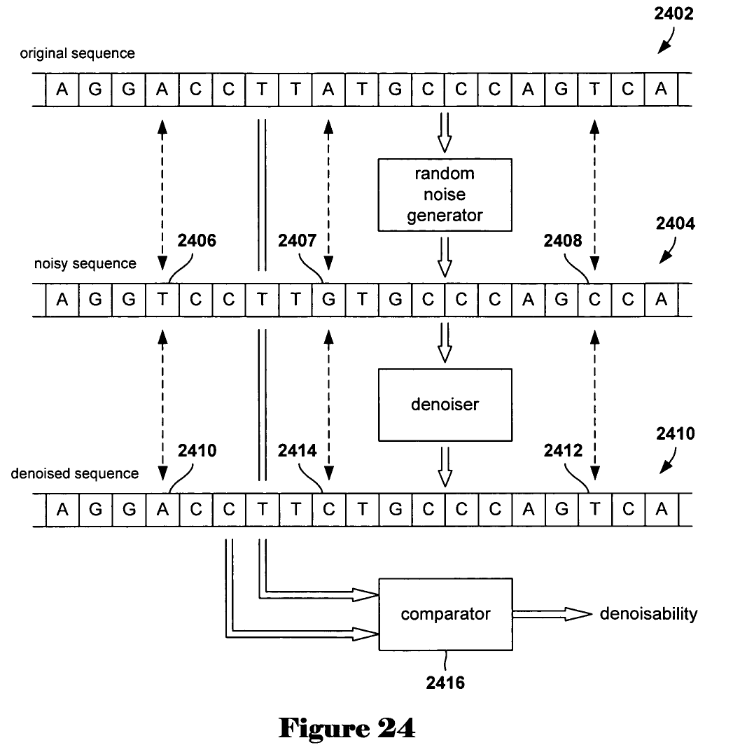

FIG. 24 illustrates one, general embodiment of the present invention. An original biopolymer sequence 2402, a short portion of which is shown in FIG. 24, is computationally processed to add noise in order to produce a noisy sequence 2404 corresponding to the original biopolymer sequence 2402, assumed to be a DNA sequence for the current example. In FIG. 24, nucleotide residues 2406-2408 have been altered by the noise generator. The random noise generator may be relatively simple, employing a pseudo-random number generator to determine, at each location of the biopolymer sequence, whether or not to replace the nucleotide at that location with another nucleotide. In the case that a nucleotide is to be replaced at a particular position, a different pseudo-random number generator may be used to select a different nucleotide to place into the noisy sequence at that position. Then, in a next step, a discrete denoiser, or other type of denoiser, is employed to denoise the noisy sequence to produce a recovered sequence 2410 that should more closely correspond to the original biopolymer sequence 2402. For example, in FIG. 24, nucleotides 2410 and 2412 in the recovered sequence have been restored to match the nucleotides in the original biopolymer sequence, while denoising has left nucleotide 2414 in the recovered sequence different from the corresponding nucleotide in the original biopolymer sequence. The recovered sequence and original biopolymer sequence are then compared by a comparative function 2416 in order to generate a measure of denoisability of the noisy sequence at each position along the sequence. The measure of denoisability may be the number of unrecovered errors within a fixed window about each position, with denoisability inversely related to the number or frequency of unrecovered errors within the window. Other denoisability metrics are possible.

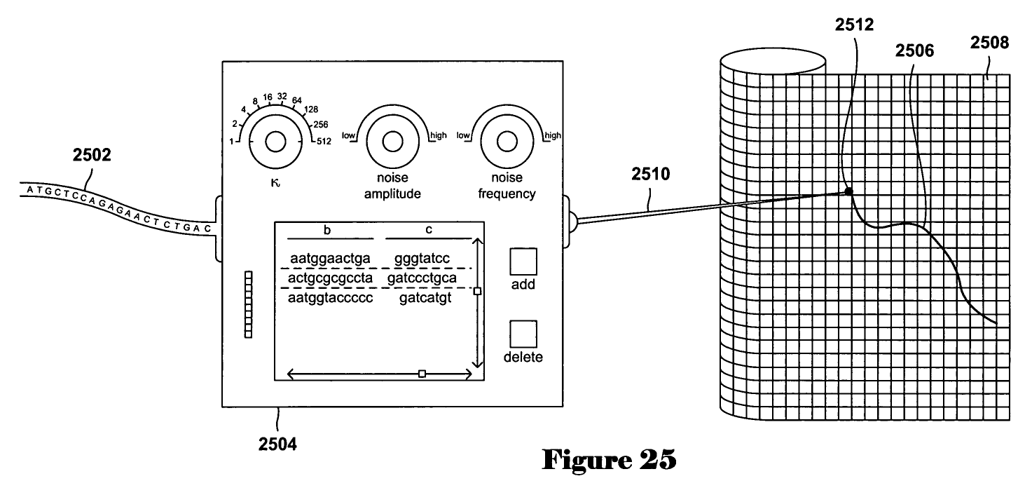

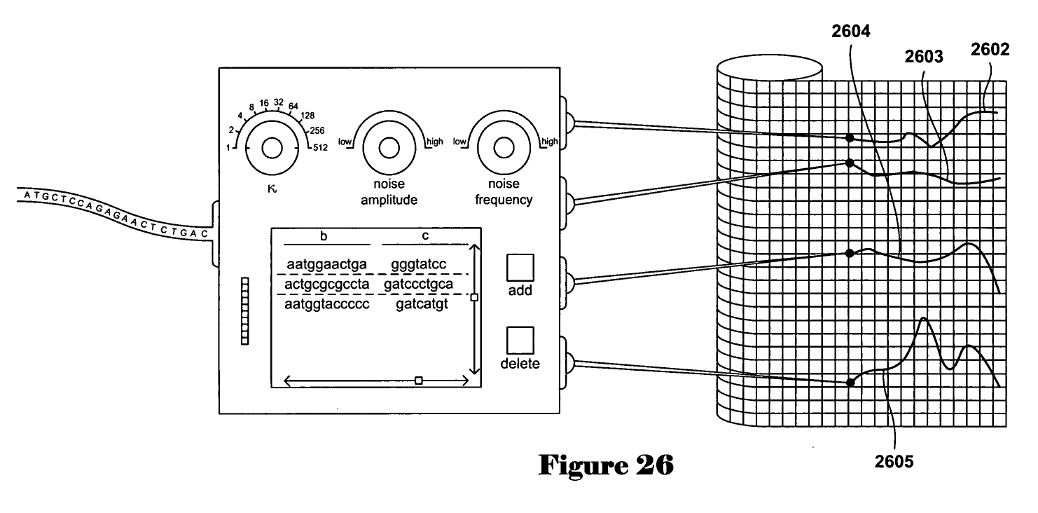

Various denoiser parameters, such as the context length k for the discrete denoiser, and various noise generator parameters, such as the frequency of introduced noise and the variability and magnitude of introduced noise, may be varied in order to produce a denoisability signal with greatest discriminating power for detecting boundaries between different types of subsequences within a biopolymer. Although many embodiments of the invention are implemented purely as software programs, the invention may be imagined as a physical laboratory device. FIG. 25 illustrates an imaginary laboratory device that illustrates aspects of the present invention. In FIG. 25, a biopolymer sequence 2502 is input into a noise-generator/denoiser box 2504 which produces an output signal 2506 on a continuous sheet of graph paper 2508 via deflection of a mechanical arm 2510 holding a pen tip 2512. The output signal 2506 is representative of the instantaneous denoisability of the input signal currently entering the box 2504. The box includes various knobs and windows to adjust denoiser parameters and noise-generator parameters in order to produce mechanical arm deflections most conducive to a useful output signal 2506 having desirable range of signal amplitude and desirable distinctness of steeply sloped sections of the output curve corresponding to biopolymer subsequence boundaries. The position on the continuous row of graph paper, or chart 2508, reflects the position with the input sequence 2502, and the height of the output curve 2506, the vertical direction corresponds to the denoisability of the input sequence at that position. FIG. 26 shows an alternate, imaginary embodiment of the present invention similar in spirit to the embodiment shown in FIG. 25. The embodiment shown in FIG. 26 outputs a number of different signals 2602-2605 corresponding not to the overall denoisability of the input signal, but instead to the noise-generator parameters and denoiser parameters needed in order to produce a constant level of denoisability For example, the context length k for the denoiser may be needed to be increased or decreased at different positions within the biopolymer sequence in order to achieve a fixed, arbitrary level of denoisability. Changes in the noise-generator and denoiser parameters may, in some cases, be more sensitive indications of biopolymer subsequence-type boundaries than the denoisability signal previously discussed.

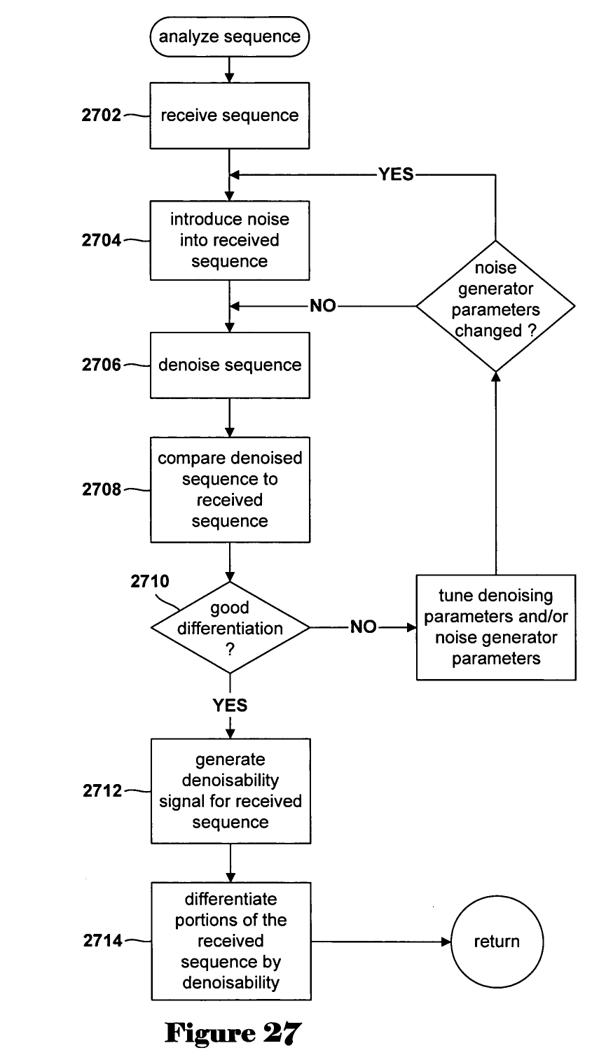

FIG. 27 is a control-flow diagram of one embodiment of the present invention implemented as a software program “analyzeSequence.” In a first step 2702, analyzeSequence receives the biopolymer sequence to be analyzed. Next, in step 2704, the program “analyzeSequence” introduces noise into the received biopolymer sequence. As discussed above, a random noise generator using one or more pseudo-random number generators may be employed to introduce noise, or more complex noise-introducing algorithms may be employed that take advantage of information particular to the type of biopolymers being analyzed, the organisms from which the biopolymer was isolated, the tissue type from which the biopolymer sequence was isolated, and other such factors. Next, in step 2706, a denoiser is used to denoise the noisy sequence produced in step 2704. The discrete denoiser, as described in a previous subsection, is a good candidate for a denoiser in this application, since a discrete denoiser exhibits favorable time and working-data-set complexities. Next, in step 2708 the denoised sequence produced in step 2706 is compared to the originally received biopolymer sequence by a comparator routine in order to generate a denoising signal reflective of the denoisability of the biopolymer sequence at each position. As discussed above, a denoisability metric may comprise the number of unrecovered errors within a window of fixed length surrounding a particular position. The metric may be normalized or otherwise processed in order to provide a more useful metric for recognizing subsequence-type boundaries within the biopolymer sequence. In step 2710, analyzeSequence determines whether the produced denoisability signal provides sufficient differentiation in order to easily recognize subsequence-type boundaries. If it does not, then analyzeSequence may tune the denoising parameters, the noise generator parameters, or both the denoising parameters and noise-generating parameters and repeat either the denoising step 2706 or both the noise introduction step 2704 and denoising step 2706, followed by denoising signal generation in step 2708. If the differentiation is sufficient to easily recognize subsequence-type boundaries, as determined in step 2710, then analyzeSequence generates a full, denoisability signal for the received biopolymer sequence in step 2712, and processes that signal to identify subsequences of different types in step 2714 based on either the level of denoisability, the slopes of the denoisability-versus-position curve, or a combination of the denoisability levels and the slopes of the curve.

Although the present invention has been described in terms of a particular embodiment, it is not intended that the invention be limited to this embodiment. Modifications within the spirit of the invention will be apparent to those skilled in the art. For example, as discussed above, any number of different types and implementations of noise generators and denoisers may be employed to produce the noisy and recovered signals corresponding to the input by a polymer sequence signal from which the denoisability metric is computed. Various different types of comparative functions may be used to produce the denoisability signal. The technique of the present invention may be employed to identify subsequence types in a variety of different biopolymers, including DNA, protein sequences, polysaccharide sequences, and other complex, information-containing biopolymers. A large variety of different subsequence types are possible, as discussed above, and the techniques of the present invention may be employed to identify new, unexpected types of subsequences with unexpected information encodings. Feedback control may be used to tune the denoisability parameters and noise-generator parameters in real time, or may be used to tune the process iteratively.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for identifying different functional subsequences within a biopolymer sequence, the method comprising:
receiving the biopolymer sequence;
introducing noise into the biopolymer sequence to produce a noisy sequence;
denoising the noisy sequence to produce a recovered sequence;
comparing the recovered sequence to the biopolymer sequence to determine a denoisability of the biopolymer sequence at positions along the biopolymer sequence; and
identifying different functional subsequences within the biopolymer sequence based on the determined denoisability of the biopolymer sequence.

2. The method of claim 1 wherein a particular functional subsequence within the biopolymer sequence is determined by a determined level of denoisability at biopolymer-sequence positions within the particular functional subsequence.

3. The method of claim 1 wherein an initial portion of a particular functional subsequence within the biopolymer sequence is determined by a steeply sloped denoisability-versus-position curve at a position within the biopolymer sequence corresponding to the initial position of the particular functional subsequence.

4. The method of claim 1 further including tuning parameters of a denoiser that denoises the noisy sequence in order to produce a denoisability signal that provides detectable discrimination of different functional subsequences within the biopolymer sequence.

5. The method of claim 4 wherein detectable discrimination is provided by detectable changes in the slope of a denoisability-versus-position curve plotted for the biopolymer sequence.

6. The method of claim 4 wherein detectable discrimination is provided by detectable changes in the height of a denoisability-versus-posifion curve plotted for the biopolymer sequence.

7. The method of claim 1 applied to one of:
a protein sequence;
a DNA sequence;
an RNA sequence; and
a polysaccharide sequence.

8. The method of claim 1 wherein denoising the noisy sequence to produce a recovered sequence is carried out by a discrete denoiser.

9. Indications of functional subsequences, stored in a computer readable medium, computed by a method for identifying different functional subsequences within a biopolymer sequence comprising:
receiving the biopolymer sequence;
introducing noise into the biopolymer sequence to produce a noisy sequence;
denoising the noisy sequence to produce a recovered sequence;
comparing the recovered sequence to the biopolymer sequence to determine a denoisability of the biopolymer sequence at positions along the biopolymer sequence; and
identifying different functional subsequences within the biopolymer sequence based on the determined denoisability of the biopolymer sequence.

10. A computer readable medium containing executable instructions which, when executed in a processing system, causes the system to perform a method for identifying different functional subsequences within a biopolymer sequence comprising:
receiving the biopolymer sequence;
introducing noise into the biopolymer sequence to produce a noisy sequence;
denoising the noisy sequence to produce a recovered sequence;
comparing the recovered sequence to the biopolymer sequence to determine a denoisability of the biopolymer sequence at positions along the biopolymer sequence; and
identifying different functional subsequences within the biopolymer sequence based on the determined denoisability of the biopolymer sequence.

11. A system that identifies different functional subsequences within a biopolyrner sequence, the system comprising:
biopolymer sequence receiving component;
noise-introduction component that introduces noise into the biopolymer sequence to produce a noisy sequence;
a denoising component that produces a recovered sequence from the noisy sequence; and
a comparison component that compares the recovered sequence to the biopolymer sequence, that determines a denoisability of the biopolymer sequence at positions along the biopolymer sequence, and that identifies different functional subsequences within the biopolymer sequence based on the determined denoisability of the biopolymer sequence.

12. The system of claim 11 wherein the comparison component identifies a particular functional subsequence within the biopolymer sequence is determined by a determined level of denoisability at biopolymer-sequence positions within the particular functional subsequence.

13. The system of claim 11 wherein the comparison component identifies an initial portion of a particular functional subsequence within the biopolymer sequence by a steeply sloped denoisability-versus-position curve at a position within the biopolymer sequence corresponding to the initial position of the particular functional subsequence.

14. The system of claim 11 further including a denoiser-tuning component that tunes parameters of the denoising component in order to produce a denoisability signal that provides detectable discrimination of different functional subsequences within the biopolymer sequence.

15. The system of claim 111 wherein the biopolymer sequence is one of:
a protein sequence;
a DNA sequence;
an RNA sequence; and
a polysaccharide sequence.

16. The system of claim 11 wherein the denoising component incorporates a discrete denoiser.
